(19) United States
(12) Patent Application Publication
(10) Pub. No.: US 2024/0327653 A1
(43) Pub. Date: Oct. 3, 2024

(54) COMPOSITION, SURFACE TREATMENT AGENT, COATING LIQUID, ARTICLE, AND METHOD FOR PRODUCING ARTICLE

(71) Applicant: AGC Inc., Tokyo (JP)

(72) Inventors: Eisuke MUROTANI, Chiyoda-ku (JP); Keigo MATSUURA, Chiyoda-ku (JP); Motoshi AOYAMA, Chiyoda-ku (JP); Hikaru ONO, Chiyoda-ku (JP); Makoto UNO, Chiyoda-ku (JP); Takafumi KAWAKAMI, Chiyoda-ku (JP)

(73) Assignee: AGC Inc., Tokyo (JP)

(21) Appl. No.: 18/659,424

(22) Filed: May 9, 2024

Related U.S. Application Data
(63) Continuation of application No. PCT/JP2022/041967, filed on Nov. 10, 2022.

(30) Foreign Application Priority Data
Nov. 12, 2021 (JP) 2021-185049

(51) Int. Cl. C09D 5/16; C08G 77/46; C09D 183/12

(52) U.S. Cl. CPC C09D 5/1675; C08G 77/46; C09D 183/12

(57) ABSTRACT

An object of the present disclosure is to provide a composition, a surface treatment agent, and a coating liquid with excellent abrasion resistance, an article including a surface layer with excellent abrasion resistance, and a method for producing the article. A composition which contains two or more compounds selected from the compound represented by the formula (A1), the compound represented by the formula (A2), the compound represented by the formula (B1), and the compound represented by the formula (B2) and meets the following (I) to (III) is provided.

R^{f1}—(OR^{f11})_{y1}—O—R¹-L¹-(R¹¹-T¹)ₓ₁ (A1)

R^{f2}—(OR^{f12})_{y2}—O—R²-L²-(R¹²-T²)ₓ₂ (A2)

(T³-R¹³)ₓ₃-L³-R³—(OR^{f13})_{y3}—O—R²³-L¹³-(R³³-T¹³)ₓ₁₃ (B1)

(T⁴-R¹⁴)ₓ₄-L⁴-R⁴—(OR^{f14})_{y4}—O—R²⁴-L¹⁴-(R³⁴-T¹⁴)ₓ₁₄ (B2)

Other symbols in the formulae are as described in the specification.

### INCORPORATION BY REFERENCE

This application is based upon and claims the benefit of priority from Japanese Patent Application 2021-185049 filed on Nov. 12, 2021, and PCT application No. PCT/JP2022/041967 filed on Nov. 10, 2022, the disclosure of which is incorporated herein in its entirety by reference.

### BACKGROUND

The present invention relates to a composition, a surface treatment agent, a coating liquid, an article, and a method for producing the article.

A fluorinated ether compound having a fluorine atom is excellent in various properties such as low refractive index, low dielectric constant, water/oil repellency, heat resistance, chemical resistance, chemical stability and transparency, and is utilized in a wide range of fields including electrical and electric materials, semiconductor materials, optical materials and surface treatment agents.

A fluorinated ether compound having a perfluoropolyether chain and a hydrolyzable silyl group is capable of forming on a surface of a substrate a surface layer having high lubricity, water/oil repellency, etc., and is thereby suitably used for a surface treatment agent. A surface treatment agent containing the fluorinated ether compound is used in an application where it is desired to maintain, for a long period of time, a performance (abrasion resistance) whereby water/oil repellency is less likely to be lowered even if the surface layer is rubbed repeatedly with fingers, and a performance (fingerprint stain removability) whereby a fingerprint adhering to the surface layer can be readily removed by wiping, for example, as a surface treatment agent for a member constituting a plane of a touch panel to be touched with fingers, a spectacle lens, a display of a wearable terminal, etc.

As a fluorinated ether compound capable of forming on a surface of a substrate a surface layer excellent in abrasion resistance, a fluorinated ether compound having a perfluoropolyether chain and a hydrolyzable silyl group has been proposed (International Patent Publication No. WO2018/143433).

### SUMMARY

As described above, a fluorinated ether compound is useful as a surface treatment agent to impart the above-described various properties, and demands for fluorinated ether compounds which can be used in various environments are increasing. The present inventors have conducted studies to further improve abrasion resistance.

An object of the present invention is to provide a composition, a surface treatment agent, and a coating liquid with excellent abrasion resistance, an article including a surface layer with excellent abrasion resistance, and a method for manufacturing the article.

The present invention provides a composition, a surface treatment agent, a coating liquid, an article, and a method for producing the article having the structures shown in the following [1]-[10].
[1] A composition which contains two or more compounds selected from the compound represented by the following formula (A1), the compound represented by the following formula (A2), the compound represented by the following formula (B1), and the compound represented by the following formula (B2) and meets the following (I) to (III).

R^{f1}—(OR^{f11})_{y1}—O—R¹-L¹-(R¹¹-T¹)ₓ₁ (A1)

R^{f2}—(OR^{f12})_{y2}—O—R²-L²-(R¹²-T²)ₓ₂ (A2)

(T³-R¹³)ₓ₃-L³-R³—(OR^{f13})_{y3}—O—R²³-L¹³-(R³³-T¹³)ₓ₁₃ (B1)

(T⁴-R¹⁴)ₓ₄-L⁴-R⁴—(OR^{f14})_{y4}—O—R²⁴-L¹⁴-(R³⁴-T¹⁴)ₓ₁₄ (B2)
where
R^{f1} is a fluoroalkyl group having 1 to 20 carbon atoms,
R^{f11} is a fluoroalkylene group having 1 to 6 carbon atoms, and when there are a plurality of R^{f11}'s, the plurality of R^{f11}'s may be the same as or different from each other,
R¹ is an alkylene group or a fluoroalkylene group,
L¹ is a single bond or a 1+x1 valent group that may contain N, O, S, or Si and may contain a branch point, and atoms bonded to R¹ and R¹¹ are each independently an N, O, S, or Si atom, a carbon atom constituting a branch point, or a carbon atom having an oxo group (═O),
R¹¹ is an alkylene group, or an alkylene group that contains an etheric oxygen atom between carbon-carbon atoms, and when there are a plurality of R¹¹'s, the plurality of R¹¹'s may be the same as or different from each other,
T¹ is —SiR^{a1}_{z1}R^{a11}_{3-z1},
x1 is an integer of at least 1,
R^{a1} is a hydroxyl group or a hydrolyzable group, and when there are a plurality of R^{a1}'s, the plurality of R^{a1}'s may be the same as or different from each other,
R^{a11} is a nonhydrolyzable group, and when there are a plurality of R^{a11}'s, the plurality of R^{a11}'s may be the same as or different from each other,
z1 is an integer from 0 to 3, and when x1 is at least 2, the plurality of z1's in the molecule may be the same as or different from each other, where at least one of z1's is an integer from 1 to 3,
y1 is an integer of at least 1,
R^{f2} is a fluoroalkyl group having 1 to 20 carbon atoms,
R^{f12} is a fluoroalkylene group having 1 to 6 carbon atoms, and when there are a plurality of R^{f12}'s, the plurality of R^{f12}'s may be the same as or different from each other,
R² is an alkylene group or a fluoroalkylene group,
L² is a single bond or a 1+x2 valent group that may contain N, O, S, or Si and may contain a branch point, and atoms bonded to R² and R¹² are each independently an N, O, S, or Si atom, a carbon atom constituting a branch point, or a carbon atom having an oxo group (═O),
R¹² is an alkylene group, or an alkylene group that contains an etheric oxygen atom between carbon-carbon atoms, and when there are a plurality of R¹²'s, the plurality of R¹²'s may be the same as or different from each other,
T² is —SiR^{a2}_{z2}R^{a12}_{3-z2},
x2 is an integer of at least 1,
R^{a2}is a hydroxyl group or a hydrolyzable group, and when there are a plurality of R^{a2}'s, the plurality of R^{a2}'s may be the same as or different from each other,
R^{a12} is a nonhydrolyzable group, and when there are a plurality of R^{a12}'s, the plurality of R^{a12}'s may be the same as or different from each other,
z2 is an integer from 0 to 3, and when x2 is at least 2, the plurality of z2's in the molecule may be the same as or different from each other, where at least one of z2's is an integer from 1 to 3,
y2 is an integer of at least 1,
R^{f13} is a fluoroalkylene group having 1 to 6 carbon atoms, and when there are a plurality of R^{f13}'s, the plurality of R^{f13}'s may be the same as or different from each other,
R³ is an alkylene group or a fluoroalkylene group,
R²³ is an alkylene group or a fluoroalkylene group,
L³ is a single bond or a 1+x3 valent group that may contain N, O, S, or Si and may contain a branch point, and atoms bonded to R³ and R¹³ are each an N, O, S, or Si atom, a carbon atom constituting a branch point, or a carbon atom having an oxo group (═O),
L¹³ is a single bond or a 1+x13 valent group that may contain N, O, S, or Si and may contain a branch point, and atoms bonded to R²³ and R³³ are each an N, O, S, or Si atom, a carbon atom constituting a branch point, or a carbon atom having an oxo group (═O),
R¹³ is an alkylene group, or an alkylene group that contains an etheric oxygen atom between carbon-carbon atoms, and when there are a plurality of R¹³'s, the plurality of R¹³'s may be the same as or 5 different from each other,
R³³ is an alkylene group, or an alkylene group that contains an etheric oxygen atom between carbon-carbon atoms, and when there are a plurality of R³³'s, the plurality of R³³'s may be the same as or different from each other,
T³ and T¹³ are each independently —SiR^{a3}_{z3}R^{a13}_{3-z3},
x3 and x13 are each independently an integer of at least 1,
R^{a3} is a hydroxyl group or a hydrolyzable group, and when there are a plurality of R^{a3}'s, the plurality of R^{a3}'s may be the same as or different from each other,
R^{a13} is a nonhydrolyzable group, and when there are a plurality of R^{a13}'s, the plurality of R^{a1}3's may be the same as or different from each other,
z3 is an integer from 0 to 3 and the plurality of z3's in the molecule may be the same as or different from each other, where at least one of z3's is an integer from 1 to 3,
y3 is an integer of at least 1,
R^{f14} is a fluoroalkylene group having 1 to 6 carbon atoms, and when there are a plurality of R^{f14}'s, the plurality of R^{f14}'s may be the same as or different from each other,
R⁴ is an alkylene group or a fluoroalkylene group,
R²⁴ is an alkylene group or a fluoroalkylene group,
L⁴ is a single bond or a 1+x4 valent group that may contain N, O, S, or Si and may contain a branch point, and atoms bonded to R⁴ and R¹⁴ are each an N, O, S, or Si atom, a carbon atom constituting a branch point, or a carbon atom having an oxo group (═O),
L¹⁴ is a single bond or a 1+x14 valent group that may contain N, O, S, or Si and may contain a branch point, and atoms bonded to R²⁴ and R³⁴ are each an N, O, S, or Si atom, a carbon atom constituting a branch point, or a carbon atom having an oxo group (═O),
R¹⁴ is an alkylene group, or an alkylene group that contains an etheric oxygen atom between carbon-carbon atoms, and when there are a plurality of R¹⁴'s, the plurality of R¹⁴'s may be the same as or different from each other,
R³⁴ is an alkylene group, or an alkylene group that contains an etheric oxygen atom between carbon-carbon atoms, and when there are a plurality of R³⁴'s, the plurality of R³⁴'s may be the same as or different from each other,
T⁴ and T¹⁴ are each independently —SiR^{a4}_{z4}R^{a14}_{3-z4},
x4 and x14 are each independently an integer of at least 1,
R^{a4} is a hydroxyl group or a hydrolyzable group, and when there are a plurality of R^{a4}'s, the plurality of R^{a4}'s may be the same as or different from each other,
R^{a14} is a nonhydrolyzable group, and when there are a plurality of R^{a14}'s, the plurality of R^{a14}'s may be the same as or different from each other,
z4 is an integer from 0 to 3 and the plurality of z4's in the molecule may be the same as or different from each other, where at least one of z4's is an integer from 1 to 3,
y4 is an integer of at least 1,
(I) when the composition contains the compound represented by the formula (A1) and the compound represented by the formula (A2),
the chain length a1 of —O—R¹-L¹-R¹¹— in the formula (A1), and
the chain length a2 of —O—R²-L²-R¹²— in the formula (A2) are different from each other,
where, when there are a plurality of T¹'s and a plurality of T²'s, at least one pair of the plurality of pairs of the chain lengths a1 and chain lengths a2 are different from each other.
(II) when the composition contains the compound represented by the formula (B1) and the compound represented by the formula (B2),
there is a difference between the lengths in at least one pair of:
a set of the chain lengths b1 of —R¹³-L³—R³—O— and the chain lengths b11 of —O—R²³-L¹³-R³³13 in the formula (B1), and
a set of the chain lengths b2 of —R¹⁴-L⁴-R⁴—O— and the chain lengths b12 of —O—R²⁴-L¹⁴-R³⁴— in the formula (B2).
(III) in a case other than the above (I) and (II),
the chain length a1 or the chain length a2 is different from one of the chain lengths b1 or the chain lengths b11 or one of the chain lengths b2 or the chain lengths b12.
[2] The composition according to [1], comprising the compound represented by the formula (A1) and the compound represented by the formula (A2) or the compound represented by the formula (B1) and the compound represented by the formula (B2).
[3] The composition according to [2], in which R^{f1} is the same as R^{f2}.
[4] The composition according to [2] to [3], in which
L¹ is the same as L², or
L³ is the same as L⁴ and L¹³ is the same as L¹⁴.
[5] The composition according to [1] to [4], in which R¹, R², R³, R⁴, R²³, and R²⁴ are each independently represented by the following formula (C).

*—(CR⁴¹₂)ₐ—(CH₂)_{b}—** . . . Formula (C)
where
R⁴¹'s are each independently a hydrogen atom, a fluorine atom, or a fluoroalkyl group, where at least one of two R⁴¹'s bonded to one carbon atom is a fluorine atom or a fluoroalkyl group,
a is an integer from 0 to 6,
b is an integer from 0 to 10,
a+b is an integer from 1 to 16,
* is a connecting bond bonded to O, and
** is a connecting bond bonded to L¹, L², L³, L⁴, L¹³, or L¹⁴.
[6] The composition according to [5], in which
a+b in R¹ and a+b in R² are values different from each other, or
a+b in R³ and a+b in R⁴ are values different from each other and
a+b in R²³ and a+b in R²⁴ are values different from each other.
[7] A surface treatment agent comprising the compound according to any one of [1] to [6].
[8] A coating liquid comprising the composition according to any one of [1] to [6] and a liquid medium.
[9] An article including a surface layer formed of the composition according to any one of [1] to [6], or the surface treatment agent according to [7] on a surface of a substrate.
[10] A method for producing an article for forming a surface layer by a dry coating method or a wet coating method using the composition according to any one of [1] to [6], the surface treatment agent according to [7], or the coating liquid according to [8].

The above and other objects, features and advantages of the present disclosure will become more fully understood from the detailed description given hereinbelow and the accompanying drawings which are given by way of illustration only, and thus are not to be considered as limiting the present disclosure.

### DESCRIPTION OF EMBODIMENTS

According to the present invention, it is possible to provide a composition, a surface treatment agent, and a coating liquid with excellent abrasion resistance, an article including a surface layer with excellent abrasion resistance, and a method for producing the article.

### BRIEF DESCRIPTION OF THE DRAWINGS

FIG. 1 is a schematic cross-sectional view showing one example of an article according to the present invention.

### DETAILED DESCRIPTION

In this specification, a compound represented by a formula (A1) is referred to as a compound (A1). The same applies to compounds represented by other formulae and the like.

A fluoroalkyl group is a generic term for a combination of a perfluoroalkyl group and a partial fluoroalkyl group. The perfluoroalkyl group means a group in which all hydrogen atoms of the alkyl group are substituted with fluorine atoms. Further, the partial fluoroalkyl group is an alkyl group in which one or more hydrogen atoms are substituted with a fluorine atom and which has one or more hydrogen atoms. That is, the fluoroalkyl group is an alkyl group having one or more fluorine atoms.

The “reactive silyl group” is a generic term for a hydrolyzable silyl group and a silanol group (Si—OH), and the “hydrolyzable silyl group” means a group capable of forming a silanol group by a hydrolysis reaction.

The “organic group” means a hydrocarbon group that may contain a substituent and may contain a hetero atom or other bond in a carbon chain.

The “hydrocarbon group” means an aliphatic hydrocarbon group (such as a linear alkylene group, a branched alkylene group, or a cycloalkylene group), an aromatic hydrocarbon group (such as a phenylene group), and a group consisting of combinations thereof.

A “surface layer” means a layer formed on a surface of a substrate.

“The chain length a1 of —O—R¹-L¹-R¹¹— in the formula (A1)” represents the number of atoms constituting the carbon chain that may have a hetero atom that links R^{f11} to T¹, and represents, when the carbon chain has a cyclic structure, the number of atoms constituting the shortest chain (connecting R^{f11} to T¹ by a minimum number of atoms). The same is applied to the chain length a2 and the like.

The “molecular weight” of the polyfluoropolyether chain is a number average molecular weight calculated from the number (average value) of oxyfluoroalkylene units on the basis of terminal groups, by means of ¹H-NMR and ¹⁹F-NMR.

The symbol “-” indicating a numerical range means that the numerical values stated before and after “-” are included as a lower limit value and an upper limit value.

### Composition

The composition of the present invention contains two or more compounds selected from the compound represented by the following formula (A1), the compound represented by the following formula (A2), the compound represented by the following formula (B1), and the compound represented by the following formula (B2) and meets the following (I) to (III).

R^{f1}—(OR^{f11})_{y1}—O—R¹-L¹-(R¹¹-T¹)ₓ₁ (A1)

R^{f2}—(OR^{f12})_{y2}—O—R²-L²-(R¹²-T²)ₓ₂ (A2)

(T³-R¹³)ₓ₃-L³-R³—(OR^{f13})_{y3}—O—R²³-L¹³-(R³³-T¹³)ₓ₁₃ (B1)

(T⁴-R¹⁴)ₓ₄-L⁴-R⁴—(OR^{f14})_{y4}—O—R²⁴-L¹⁴-(R³⁴-T¹⁴)ₓ₁₄ (B2)
where
R^{f1} is a fluoroalkyl group having 1 to 20 carbon atoms,
R^{f11} is a fluoroalkylene group having 1 to 6 carbon atoms, and when there are a plurality of R^{f11}'s, the plurality of R^{f11}'s may be the same as or different from each other,
R¹ is an alkylene group or a fluoroalkylene group,
L¹ is a single bond or a 1+x1 valent group that may contain N, O, S, or Si and may contain a branch point, and atoms bonded to R¹ and R¹¹ are each independently an N, O, S, or Si atom, a carbon atom constituting a branch point, or a carbon atom having an oxo group (═O),
R¹¹ is an alkylene group, or an alkylene group that contains an etheric oxygen atom between carbon-carbon atoms, and when there are a plurality of R¹¹'s, the plurality of R¹¹'s may be the same as or different from each other,
T¹ is —SiR^{a1}_{z1}R^{a11}_{3-z1},
x1 is an integer of at least 1,
R^{a1} is a hydroxyl group or a hydrolyzable group, and when there are a plurality of R^{a1}'s, the plurality of R^{a1}'s may be the same as or different from each other,
R^{a11} is a nonhydrolyzable group, and when there are a plurality of R^{a11}'s, the plurality of R^{a11}'s may be the same as or different from each other,
z1 is an integer from 0 to 3, and when x1 is at least 2, the plurality of z1's in the molecule may be the same as or different from each other, where at least one of z1's is an integer from 1 to 3,
y1 is an integer of at least 1,
R^{f2} is a fluoroalkyl group having 1 to 20 carbon atoms,
R^{f12} is a fluoroalkylene group having 1 to 6 carbon atoms, and when there are a plurality of R^{f12}'s, the plurality of R^{f12}'s may be the same as or different from each other,
R² is an alkylene group or a fluoroalkylene group,
L² is a single bond or a 1+x2 valent group that may contain N, O, S, or Si and may contain a branch point, and atoms bonded to R² and R¹² are each independently an N, O, S, or Si atom, a carbon atom constituting a branch point, or a carbon atom having an oxo group (═O),
R¹² is an alkylene group, or an alkylene group that contains an etheric oxygen atom between carbon-carbon atoms, and when there are a plurality of R¹²'s, the plurality of R¹²'s may be the same as or different from each other,
T² is —SiR^{a2}_{z2}R^{a12}_{3-z2},
x2 is an integer of at least 1,
R^{a2} is a hydroxyl group or a hydrolyzable group, and when there are a plurality of R^{a2}'s, the plurality of R^{a2}'s may be the same as or different from each other,
R^{a12} is a nonhydrolyzable group, and when there are a plurality of R^{a12}'s, the plurality of R^{a12}'s may be the same as or different from each other,
z2 is an integer from 0 to 3, and when x2 is at least 2, the plurality of z2's in the molecule may be the same as or different from each other, where at least one of z2's is an integer from 1 to 3,
y2 is an integer of at least 1,
R^{f13} is a fluoroalkylene group having 1 to 6 carbon atoms, and when there are a plurality of R^{f13}'s, the plurality of R^{f13}'s may be the same as or different from each other,
R³ is an alkylene group or a fluoroalkylene group,
R²³ is an alkylene group or a fluoroalkylene group,
L³ is a single bond or a 1+x3 valent group that may contain N, O, S, or Si and may contain a branch point, and atoms bonded to R³ and R¹³ are each an N, O, S, or Si atom, a carbon atom constituting a branch point, or a carbon atom having an oxo group (═O),
L¹³ is a single bond or a 1+x13 valent group that may contain N, O, S, or Si and may contain a branch point, and atoms bonded to R²³ and R³³ are each an N, O, S, or Si atom, a carbon atom constituting a branch point, or a carbon atom having an oxo group (═O),
R¹³ is an alkylene group, or an alkylene group that contains an etheric oxygen atom between carbon-carbon atoms, and when there are a plurality of R¹³'s, the plurality of R¹³'s may be the same as or different from each other,
R³³ is an alkylene group, or an alkylene group that contains an etheric oxygen atom between carbon-carbon atoms, and when there are a plurality of R³³'s, the plurality of R³³'s may be the same as or different from each other,
T³ and T¹³ are each independently —SiR^{a3}_{z3}R^{a13}_{3-z3},
x3 and x13 are each independently an integer of at least 1,
R^{a3} is a hydroxyl group or a hydrolyzable group, and when there are a plurality of R^{a3}'s, the plurality of R^{a3}'s may be the same as or different from each other,
R^{a13} is a nonhydrolyzable group, and when there are a plurality of R^{a13}'s, the plurality of R^{a1}3's may be the same as or different from each other,
z3 is an integer from 0 to 3 and the plurality of z3's in the molecule may be the same as or different from each other, where at least one of z3's is an integer from 1 to 3,
y3 is an integer of at least 1,
R^{f14} is a fluoroalkylene group having 1 to 6 carbon atoms, and when there are a plurality of R^{f14}'s, the plurality of R^{f14}'s may be the same as or different from each other,
R⁴ is an alkylene group or a fluoroalkylene group,
R²⁴ is an alkylene group or a fluoroalkylene group,
L⁴ is a single bond or a 1+x4 valent group that may contain N, O, S, or Si and may contain a branch point, and atoms bonded to R⁴ and R¹⁴ are each an N, O, S, or Si atom, a carbon atom constituting a branch point, or a carbon atom having an oxo group (═O),
L¹⁴ is a single bond or a 1+x14 valent group that may contain N, O, S, or Si and may contain a branch point, and atoms bonded to R²⁴ and R³⁴ are each an N, O, S, or Si atom, a carbon atom constituting a branch point, or a carbon atom having an oxo group (═O),
R¹⁴ is an alkylene group, or an alkylene group that contains an etheric oxygen atom between carbon-carbon atoms, and when there are a plurality of R¹⁴'s, the plurality of R¹⁴'s may be the same as or different from each other,
R³⁴ is an alkylene group, or an alkylene group that contains an etheric oxygen atom between carbon-carbon atoms, and when there are a plurality of R³⁴'s, the plurality of R³⁴'s may be the same as or different from each other,
T⁴ and T¹⁴ are each independently —SiR^{a4}_{z4}R^{a14}_{3-z4},
x4 and x14 are each independently an integer of at least 1,
R^{a4} is a hydroxyl group or a hydrolyzable group, and when there are a plurality of R^{a4}'s, the plurality of R^{a4}'s may be the same as or different from each other,
R^{a14} is a nonhydrolyzable group, and when there are a plurality of R^{a14}'s, the plurality of R^{a14}'s may be the same as or different from each other,
z4 is an integer from 0 to 3 and the plurality of z4's in the molecule may be the same as or different from each other, where at least one of z4's is an integer from 1 to 3,
y4 is an integer of at least 1, (1) when the composition contains the compound represented by the formula (A1) and the compound represented by the formula (A2), the chain length a1 of —O—R¹-L¹-R¹¹— in the formula (A1), and
the chain length a2 of —O—R²-L²-R¹²— in the formula (A2) are different from each other,
where, when there are a plurality of T¹'s and a plurality of T²'s, at least one pair of the plurality of pairs of the chain lengths a1 and chain lengths a2 are different from each other.
(II) when the composition contains the compound represented by the formula (B1) and the compound represented by the formula (B2),
there is a difference between the lengths in at least one pair of:
a set of the chain lengths b1 of —R¹³-L³-R³—O— and the chain lengths b11 of —O—R²³-L¹³-R³³— in the formula (B1), and
a set of the chain lengths b2 of —R¹⁴-L⁴-R⁴—O— and the chain lengths b12 of —O—R²⁴-L¹⁴-R³⁴— in the formula (B2).
(III) in a case other than the above (I) and (II),
the chain length a1 or the chain length a2 is different from one of the chain lengths b1 or the chain lengths b11 or one of the chain lengths b2 or the chain lengths b12.

The compounds A1 and A2 generally have a structure of “polyfluoropolyether chain-linking group-reactive silyl group”. The compounds B1 and B2 generally have a structure of “reactive silyl group-linking group-polyfluoropolyether chain-linking group-reactive silyl group”. Since the above reactive silyl group is strongly chemically bonded to a substrate, the surface layer formed using the present compound is excellent in abrasion resistance. Further, since the present compound has a polyfluoropolyether chain, the surface layer is excellent in fingerprint stain removability.

The present composition uses two or more compounds of the aforementioned compounds whose lengths between the polyfluoropolyether chain and the reactive silyl group are different from each other, that is, the chain lengths of the linking group are different from each other in combination with each other. Accordingly, the present composition can be adapted to fit micro-irregularities on the substrate surface and can be strongly bonded thereto. Further, since the present composition contains a (long-chain) compound in which the above chain length is long and a (short-chain) compound in which the above chain length is short, reduction in the abrasion resistance due to a long-chain compound can be compensated for by the abrasion resistance of the short-chain compound and is excellent in abrasion resistance.

As described above, the present composition is excellent in abrasion resistance, and is useful as a surface treatment agent capable of forming a surface layer which is excellent in abrasion resistance.

### Compound (A1)

R^{f1} is a fluoroalkyl group having 1 to 20 carbon atoms. This fluoroalkyl group may be linear or may have a branch. The fluoroalkyl group is preferably a linear fluoroalkyl group in view of wear resistance, and the number of carbon atoms in the fluoroalkyl group is preferably from 1 to 6, and more preferably from 1 to 3 in view of ease of preparation and the like.

R^{f11} is a fluoroalkylene group having 1 to 6 carbon atoms, and when there are a plurality of R^{f11}'s, the plurality of R^{f11}'s may be the same as or different from each other. (OR^{f11})_{y1} is a polyfluoropolyether chain, and y1 is an integer of at least 1.

The polyfluoropolyether chain in (OR^{f11})_{y1} preferably has a structure represented by the following formula (G1).

—[(OG^{f1})ₘ₁(OG^{f2})ₘ₂(OG^{f3})ₘ₃(OG^{f4})ₘ₄(OG^{f5})ₘ₅(OG^{f6})ₘ₆]- Formula (G1)
where, in the formula,
G^{f1} is a fluoroalkylene group having 1 carbon atom,
G^{f2} is a fluoroalkylene group having 2 carbon atoms,
G^{f3} is a fluoroalkylene group having 3 carbon atoms,
G^{f4} is a fluoroalkylene group having 4 carbon atoms,
G^{f5} is a fluoroalkylene group having 5 carbon atoms,
G^{f6} is a fluoroalkylene group having 6 carbon atoms,
m1, m2, m3, m4, m5, and m6 each independently represent 0 or an integer of at least 1, and m1+m2+m3+m4+m5+m6 is preferably an integer from 1 to 200.

The bonding order of (OG^{f1}) to (OG^{f6}) in the formula (G1) may be arranged randomly. In the above formula (G1), m1 to m6 respectively represent the number of (OG^{f1}) to (OG^{f6}), not the arrangement of them. For example, (OG^{f5})ₘ₅ represents that the number of (OG^{f5}) is m5, not the block arrangement structure of (OG^{f5})ₘ₅. Likewise, the order of description of (OG^{f1}) to (OG^{f6}) does not represent the bonding order of the respective units.

Further, the fluoroalkylene group having 3 to 6 carbon atoms may be a linear fluoroalkylene group or a fluoroalkylene group having a branched or cyclic structure.

Specific examples of G^{f1} include —CF₂—, and —CHF—.

Specific examples of G^{f2} include —CF₂CF₂—, —CHFCF₂—, —CHFCHF—, —CH₂CF₂—, and —CH₂CHF—.

Specific examples of G^{f3} include —CF₂CF₂CF₂—, —CF₂CHFCF₂—, —CF₂CH₂CF₂—, —CHFCF₂CF₂—, —CHFCHFCF₂—, —CHFCHFCHF—, —CHFCH₂CF₂—, —CH₂CF₂CF₂—, —CH₂CHFCF₂—, —CH₂CH₂CF₂—, —CH₂CF₂CHF—, —CH₂CHFCHF—, —CH₂CH₂CHF—, —CF(CF₃)—CF₂—, —CF(CHF₂)—CF₂—, —CF(CH₂F)—CF₂—, —CF(CH₃)—CF₂—, —CF(CF₃)—CHF—, —CF(CHF₂)—CHF—, —CF(CH₂F)—CHF—, —CF(CH₃)—CHF—, —CF(CF₃)—CH₂—, —CF(CHF₂)—CH₂—, —CF(CH₂F)—CH₂—, —CF(CH₃)—CH₂—, —CH(CF₃)—CF₂—, —CH(CHF₂)—CF₂—, —CH(CH₂F)—CF₂—, —CH(CH₃)—CF₂—, —CH(CF₃)—CHF—, —CH(CHF₂)—CHF—, —CH(CH₂F)—CHF—, —CH(CH₃)—CHF—, —CH(CF₃)—CH₂—, —CH(CHF 2)—CH₂—, -and CH(CH₂F)—CH₂—.

Specific examples of G^{f4} include —CF₂CF₂CF₂CF₂—, —CHFCF₂CF₂CF₂—, —CH₂CF₂CF₂CF₂—, —CF₂CHFCF₂CF₂—, —CHFCHFCF₂CF₂—, —CH₂CHFCF₂CF₂—, —CF₂CH₂CF₂CF₂—, —CHFCH₂CF₂CF₂—, —CH₂CH₂CF₂CF₂—, —CHFCF₂CHFCF₂—, —CH₂CF₂CHFCF₂—, —CF₂CHFCHFCF₂—, —CHFCHFCHFCF₂—, —CH₂CHFCHFCF₂—, —CF₂CH₂CHFCF₂—, —CHFCH₂CHFCF₂—, —CH₂CH₂CHFCF₂—, —CF₂CH₂CH₂CF₂—, —CHFCH₂CH₂CF₂—, —CH₂CH₂CH₂CF₂—, —CHFCH₂CH₂CHF—, —CH₂CH₂CH₂CHF—, and -cycloC₄F₆—.

Specific examples of G^{f5} include —CF₂CF₂CF₂CF₂CF₂—, —CHFCF₂CF₂CF₂CF₂—, —CH₂CHFCF₂CF₂CF₂—, —CF₂CHFCF₂CF₂CF₂—, —CHFCHFCF₂CF₂CF₂—, —CF₂CH₂CF₂CF₂CF₂—, —CHFCH₂CF₂CF₂CF₂—, —CH₂CH₂CF₂CF₂CF₂—, —CF₂CF₂CHFCF₂CF₂—, —CHFCF₂CHFCF₂CF₂—, —CH₂CF₂CHFCF₂CF₂—, —CH₂CF₂CF₂CF₂CH₂—, and -cycloC₅F₈—.

Specific examples of G^{f6} include —CF₂CF₂CF₂CF₂CF₂CF₂—, —CF₂CF₂CHFCHFCF₂CF₂—, —CHFCF₂CF₂CF₂CF₂CF₂—, —CHFCHFCHFCHFCHFCHF—, —CHFCF₂CF₂CF₂CF₂CH₂—, —CH₂CF₂CF₂CF₂CF₂CH₂—, and -cycloC₆F₁₀—.

-cycloC₄F₆— means a perfluorocyclobutanediyl group, and specific examples thereof include a perfluorocyclobutan-1,2-diyl group. -cycloC₅F₈— means a perfluorocyclopentanediyl group, and specific examples thereof include a perfluorocyclopentane-1,3-diyl group. -cycloC₆F₁₀— means a perfluorocyclohexanediyl group, and specific examples thereof include a perfluorocyclohexane-1,4-diyl group.

Among them, (OR^{f11})_{y1} preferably has a structure represented by the following formulae (G2) to (G4) in view of further excellent water/oil repellency, abrasion resistance, and fingerprint stain removability.

(OG^{f1})ₘ₁-(OG^{f2})ₘ₂ Formula (G2)

(OG^{f2})ₘ₂-(OG^{f4})ₘ₄ Formula (G3)

(OG^{f3})ₘ₃ Formula(G4)
where, the symbols of the formulae (G2) to (G4) are similar to those in the aforementioned formula (G1).

In the formulae (G2) and (G3), the bonding order of (OG^{f1}) and (OG^{f2}), and the bonding order of (OG^{f2}) and (OG^{f4}) may be arranged randomly. For example, in the formula (G2), (OG^{f1}) and (OG^{f2}) may be arranged alternately, and (OG^{f1}) and (OG^{f2}) may be each arranged in a block, or may be arranged randomly. The same holds true for the formula (G3).

In the formula (G2), m1 is preferably from 1 to 30, and more preferably from 1 to 20. Further, m2 is preferably from 1 to 30, and more preferably from 1 to 20.

In the formula (G3), m2 is preferably from 1 to 30, and more preferably from 1 to 20. Further, m4 is preferably from 1 to 30, and more preferably from 1 to 20.

In the formula (G4), m3 is preferably from 1 to 30, and more preferably from 1 to 20.

The proportion of fluorine atoms in the polyfluoropolyether chain (OR^{f11})_{y1} [{number of fluorine atoms/(number of fluorine atoms+number of hydrogen atoms)}×100 (%)] is, in view of excellent water/oil repellency and fingerprint stain removability, preferably at least 40%, more preferably at least 50%, and further preferably at least 60%.

Further, the molecular weight of the polyfluoropolyether chain (OR^{f11})_{y1} part is preferably from 200 to 30,000, more preferably from 600 to 25,000, and further preferably from 1,000 to 20,000 in view of wear resistance.

R¹ is an alkylene group or a fluoroalkylene group. In view of ease of preparation and the like, the alkylene group and the fluoroalkylene group in R¹ is preferably linear. The number of atoms in R¹ is preferably from 1 to 16, and more preferably from 1 to 12. Further, in view of case of preparation, R¹ is preferably an alkylene group or a fluoroalkylene group in which a carbon atom bonded to L¹ or R¹¹ (when L¹ is a single bond) is bonded to two hydrogen atoms, or a C1-3 fluoroalkylene group.

Further, R¹ is preferably a group represented by the following formula (C) in view of ease of adjustment of the chain length.

*—(CR⁴¹₂)ₐ—(CH₂)_{b}—** Formula (C)
where
R⁴¹'s are each independently a hydrogen atom, a fluorine atom, or a fluoroalkyl group, at least one of two R⁴¹'s bonded to one carbon atom is a fluorine atom or a fluoroalkyl group, and the plurality of R⁴¹'s may be the same as or different from each other,
a is an integer from 0 to 6,
b is an integer from 0 to 10,
a+b is an integer from 1 to 16,
* is a connecting bond bonded to O, and
** is a connecting bond bonded to L¹.

In the formula (C), (CR⁴¹₂)ₐ—(CH₂)_{b} indicates a bonding order, and when a and b are at least 1, the block of CR⁴¹₂ is arranged on the (OR^{f11})_{y1}—O side and the block of CH₂ is arranged on the L¹ side.

The number of atoms of the fluoroalkyl group in R⁴¹ is preferably from 1 to 6, more preferably from 1 to 3, and further preferably from 1 to 2. Among them, R⁴¹ is preferably a fluorine atom, or a C1-3 fluoroalkyl group, and more preferably a fluorine atom.

The symbol a may be an integer from 0 to 6, preferably from 1 to 6, more preferably from 1 to 4, and further preferably from 1 to 3.

Further, b may be an integer from 0 to 10, preferably from 1 to 8, and more preferably from 1 to 6.

Preferable specific examples of R¹ include —CF₂—, —CF₂CF₂—, —CF₂CH₂—, —CF₂CF₂CF₂—, —CF₂CF₂CH₂—, —CF₂CF₂CF₂CH₂—, —CF₂CH₂CH₂CH₂—, —CF₂CF₂CF₂CH₂CH₂—, —CF₂CH₂CH₂ CH₂CH₂ CH₂—, —CF₂CF₂CF₂CH₂CH₂CH₂CH₂—, and —CF₂CF₂CF₂CH₂CH₂ CH₂CH₂CH₂CH₂—.

L¹ is a single bond or a 1+x1 valent group that may contain N, O, S, or Si and may contain a branch point, and atoms bonded to R¹ and R¹¹ are each independently an N, O, S, or Si atom, a carbon atom constituting a branch point, or a carbon atom having an oxo group (═O). Note that the atoms bonded to R¹ and R¹¹ may be the same as or may be different from each other.

When L¹ is a single bond, R¹ and R¹¹ in the formula (A1) are directly bonded to each other and the compound (A1) is represented by the following formula (A1′).

R^{f1}—(OR^{f11})_{y1}—O—R¹—R¹¹-T¹ (A1′)
where the symbols in the formula (A1′) are similar to those in the formula (A1).

When L¹ is a trivalent or higher group, L¹ has at least one branch point (hereinafter referred to as a “branch point P¹”) selected from the group consisting of C, N, Si, a cyclic structure, and a (1+x1) valent organopolysiloxane residue.

When N is the branch point P¹, the branch point P¹ is represented, for example, by *—N(—**)₂. Here, * is a connecting bond on the R¹ side and ** is a connecting bond on the R¹¹ side.

When C is the branch point P¹, the branch point P¹ is represented, for example, by *—C(—**)₃ or *—CR²⁹(—**)₂. Here, * is a connecting bond on the R¹ side, ** is a connecting bond on the R¹¹ side, R²⁹ is a monovalent group such as, for example, a hydrogen atom, a hydroxyl group, an alkyl group, an alkoxy group or the like.

When Si is the branch point P¹, the branch point P¹ is represented, for example, by *—Si(—**)₃ or *—SiR²⁹(—**)₂. Here, * is a connecting bond on the R¹ side, ** is a connecting bond on the R¹¹ side, R²⁹ is a monovalent group such as, for example, a hydrogen atom, a hydroxyl group, an alkyl group, an alkoxy group or the like.

To facilitate the preparation of the present compound and provide a surface layer having further enhanced abrasion resistance, light resistance, and chemical resistance, the cyclic structure constituting the branch point P¹ is preferably one selected from the group consisting of 3- to 8-membered aliphatic rings, 3- to 8-membered aromatic rings, 3- to 8-membered heterorings, and condensation rings consisting of two or more of these rings, and is particularly preferably the cyclic structures shown in the formulae below. The cyclic structure may have a substituent such as a halogen atom, an alkyl group (which may have an etheric oxygen atom between carbon-carbon atoms), a cycloalkyl group, an alkenyl group, an allyl group, an alkoxy group, or an oxo group (═O).

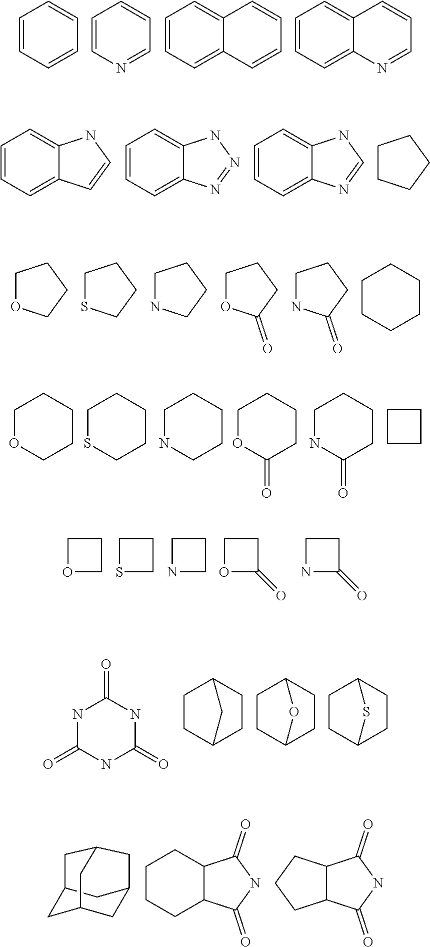

Specific examples of the organopolysiloxane residue constituting the branch point P¹ include the following groups. Here, R²⁵ in the formulae below is a hydrogen atom, an alkyl group, an alkoxy group, or a phenyl group. The alkyl group and the alkoxy group of R²³ preferably have 1 to 10 carbon atoms, more preferably one carbon atom.

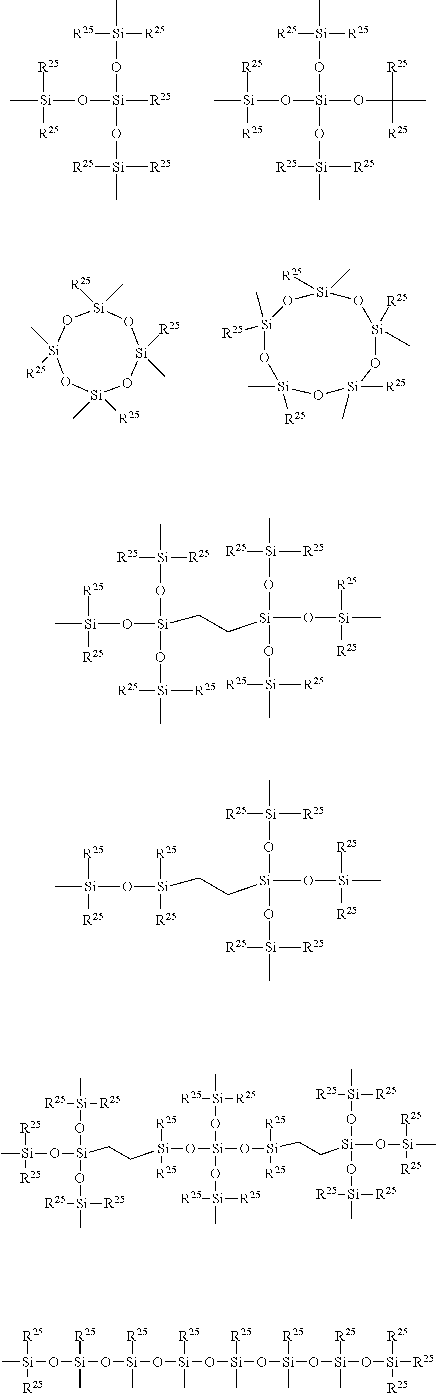

The divalent or higher L¹ may contain at least one bond (hereinafter referred to as a “bond B¹”) selected from the group consisting of —C(O)N(R²⁶)—, —N(R²⁶)C(O)—, —C(O)O—, —OC(O)—, —C(O)—, —O—, —N(R²⁶)—, —S—, —OC(O)O—, —NHC(O)O—, —OC(O)NH—, —NHC(O)N(R²⁶)—, —SO₂N(R²⁶)—, —N(R²⁶)SO₂—, —Si(R²⁶)₂—, —OSi(R²⁶)2—, —Si(CH₃)₂-Ph-Si(CH₃)₂—, and a divalent organopolysiloxane residue.

Here, R²⁶ is a hydrogen atom, an alkyl group having 1 to 6 carbon atoms, or a phenyl group, and Ph is a phenylene group. From the viewpoint of ease of production of the present compound, the number of carbon atoms in the alkyl group of R²⁶ is preferably from 1 to 6, more preferably from 1 to 3, particularly preferably from 1 to 2.

Specific examples of the divalent organopolysiloxane residue include the groups shown in the following formulae. In the following formulae, R²⁷ is a hydrogen atom, an alkyl group, an alkoxy group, or a phenyl group. The number of carbon atoms in the alkyl group and the alkoxy group of R²⁷ is preferably from 1 to 10, and more preferably 1.

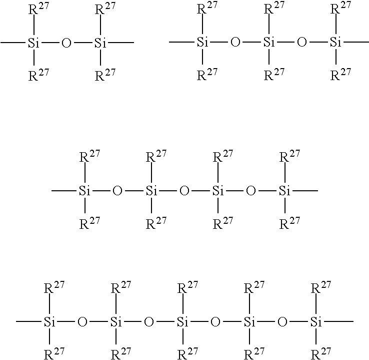

The bond B¹ is, in view of ease of production of the present compound, preferably at least one bond selected from the group consisting of —C(O)NR²⁶—, —N(R²⁶) C(O)—, —C(O)—, and —NR²⁶—, and in view of more excellent light resistance and chemical resistance of the surface layer, more preferably —C(O)NR²⁶—, —N(R²⁶)C(O)—, or —C(O)—.

In the trivalent or higher L¹, atoms bonded to R¹ and R¹¹ are each independently an N, O, S, or Si atom, a carbon atom constituting a branch point, or a carbon atom having an oxo group (═O). That is, atoms adjacent to R¹ and R¹¹ are each constituent element of the bond B¹ or branch point P¹. Specific examples of the trivalent or higher L¹ include at least one branch point P¹(e.g., {*-P¹ (-**)ₓ₁}), a combination of at least one branch point P¹ with at least one bond B¹ (e.g., {*-B¹-R²⁸-P¹(-**)ₓ₁}, {*-B¹-R²⁸-P¹(-R²⁸-B¹-**)ₓ₁}), etc. Here, R²⁸ is a single bond or a divalent organic group, * is a connecting bond on the R¹ side, and ** is a connecting bond on the R¹¹ side.

In the divalent L¹, atoms bonded to R¹ and R¹¹ are each independently an N, O, S, or Si atom, or a carbon atom having an oxo group (═O). That is, atoms adjacent to R¹ and R¹¹ are each constituent element of the bond B¹. Specific examples of the divalent or higher L¹ include a single bond, at least one bond B¹ (e.g., , *-B¹-** , *-B¹-R²⁸-B¹-**), etc. Here, R²⁸ is a single bond or a divalent organic group, * is a connecting bond on the R¹ side, and ** is a connecting bond on the R¹¹ side.

Examples of the divalent organic group in the above R²⁸ include, for example, a hydrocarbon group such as a divalent aliphatic hydrocarbon group (such as an alkylene group or a cycloalkylene group), or a divalent aromatic hydrocarbon group (such as a phenylene group). The divalent organic group in the above R²⁸ may have the bond B¹ between carbon-carbon atoms of the hydrocarbon group having at least 2 carbon atoms. The number of carbon atoms in the divalent organic group is preferably from 1 to 10, more preferably from 1 to 6, and particularly preferably from 1 to 4.

The L¹ is, in view of ease of production of the present compound, preferably a group represented by any one of the following formulae (Q1) to (Q7).

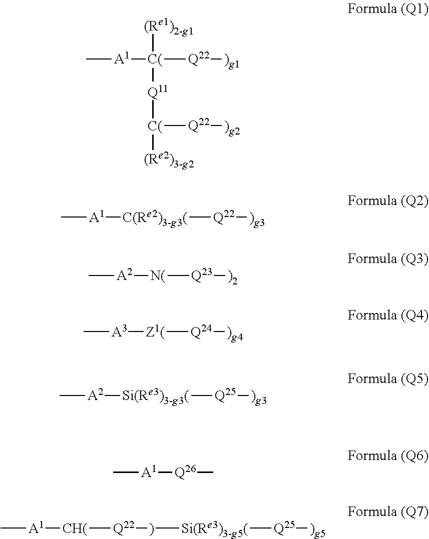

where, in the formulae (Q1) to (Q7), the A¹, A², or A³ side is connected to R¹ in the formula (A1) and the Q²², Q²³, Q²⁴, Q²⁵, or Q²⁶ side is connected to (R¹¹-T¹)ₓ₁.

Here, A¹ is a single bond, -B²-, -B³-R³⁰—, or -B³-R³⁰-B²-, R³⁰ is an alkylene group, or a group having —C(O)NR^{e6}—, —C(O)—, —NR^{e6}—, or —O— between carbon-carbon atoms of an alkylene group having at least 2 carbon atoms, B² is —C(O) NR⁶—, —C(O)—, —NR²⁶—, or —O—, and B³ is —C(O)NR^{e6}—, —C(O)—, or —NR^{e6}—,
A² is a single bond or —B³—R³⁰—,
A³ is A¹ when the atom in Z¹ to which A³ is bonded is a carbon atom and is A² when the atom in Z¹ to which A³ is bonded is a nitrogen atom,
Q¹¹ is a single bond, —O—, an alkylene group, or a group having —C(O)NR^{e6}—, —C(O)—, —NR^{e6}—, or —O— between carbon-carbon atoms of an alkylene group having at least 2 carbon atoms,
Q²² is a single bond, -B²-, -R³⁰-B³-, or -B²-R³⁰-B³-, and when there are at least two Q²²'s, the at least two Q²²'s may be the same as or different from each other,
Q²³ is a single bond, or —R³⁰-B³-, and two Q²³'s may be the same as or different from each other,
Q²⁴ is Q²² when the atom in Z¹ to which Q²⁴ is bonded is a carbon atom and is Q²³ when the atom in Z¹ to which Q²⁴ is bonded is a nitrogen atom, and when there are at least two Q²⁴'s, the at least two Q²⁴'s may be the same as or different from each other,
Q²⁵ is a single bond, or —R³⁰-B³-, and when there are at least two Q²⁵'s, the at least two Q²⁵'s may be the same as or different from each other,
Q²⁶ is a single bond, or —R³⁰-B³-,
Z¹ is a group having a (g4+1) valent cyclic structure having a carbon atom or a nitrogen atom to which A³ is directly bonded and a carbon atom or a nitrogen atom to which Q²⁴ is directly bonded,
R^{e1} is a hydrogen atom or an alkyl group, and when there are at least two R^{e1}'s, the at least two R^{e1}'s may be the same as or different from each other,
R^{e2} is a hydrogen atom, a hydroxyl group, an alkyl group, or an acyloxy group,
e1 R^{e3} is an alkyl group,
R^{e6} is a hydrogen atom, an alkyl group having 1 to 6 carbon atoms, or a phenyl group,
g1 is an integer from 0 to 3, g2 is an integer from 0 to 3, and g1+g2 is an integer from 1 to 6,
g3 is an integer from 1 to 3,
g4 is an integer of at least 1, and
g5 is an integer from 1 to 3.

Note that g1+g2=x1, g3=x1, g4=x1, and g5=x1.

The number of carbon atoms in the alkylene group of R³⁰ is, in view of ease of production of the present compound, and in that the resulting surface layer will be more excellent in abrasion resistance, light resistance, and chemical resistance, preferably from 1 to 10, more preferably from 1 to 6, and further preferably from 1 to 4, provided that when the alkylene group has a specific bond between carbon-carbon atoms, the lower limit value is 2.

As the cyclic structure in Z¹, the 1+g4 valent residue having a cyclic structure constituting the aforementioned branch point P¹ may be mentioned, and the preferred embodiments are also the same. Since Q²⁴ is directly bonded to the cyclic structure in Z¹, there is no case in which, for example, an alkylene group is linked to the cyclic structure and Q²⁴ is linked to the alkylene group.

The number of carbon atoms in the alkyl group of R^{e1}, R^{e2}, or R^{e3} is, in view of ease of production of the present compound, preferably from 1 to 6, more preferably from 1 to 3, and further preferably from 1 to 2.

The number of carbon atoms in the alkyl group moiety in the acyloxy group of R^{e2} is, in view of ease of production of the compound 1, preferably from 1 to 6, more preferably from 1 to 3, and further preferably from 1 to 2.

g4 is, in view of ease of production of the present compound, and in that the resulting surface layer will be more excellent in abrasion resistance and fingerprint stain removability, preferably from 2 to 6, more preferably from 2 to 4, further preferably 2 or 3.

As other embodiments of the above L¹, a group represented by one of the following formulae (Q11) to (Q17) may be mentioned.

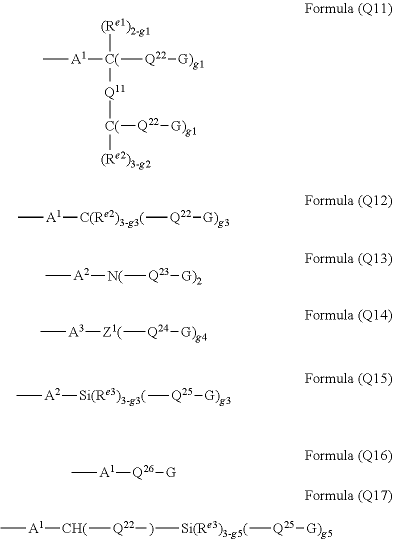

However, in the formulae (Q11) to (Q17), the A¹, A², or A³ side is connected to R¹ in the formula (A1) and the Q²², Q²³, Q²⁴, Q²⁵, or Q²⁶ side is connected to (R¹¹-T¹)ₓ₁. G is the following group g3, and at least two G's that L¹ contains may be the same as or different from each other. The symbols other than G are the same as those in the formulae (Q¹) to (Q⁷).

—Si(R²¹)₃₋ₖ(-Q³-)ₖ Formula g3
where in the formula g3, the Si side is connected to Q²², Q²³, Q²⁴, Q²⁵, or Q²⁶ and the Q³ side is connected to (R¹¹-T¹)ₓ₁. R²¹ is an alkyl group. Q³ is a single bond, or —R³¹-B³-, R³¹ is an alkylene group, or a group having —C(O)NR³²—, —C(O)—, —NR³²—, or —O— between carbon-carbon atoms of an alkylene group having at least 2 carbon atoms, or —(OSi(R²²)₂)ₚ—O—, the at least two Q³'s may be the same as or different from each other. k is 2 or 3. R³² is a hydrogen atom, an alkyl group having 1 to 6 carbon atoms, or a phenyl group. R²² is an alkyl group, a phenyl group, or an alkoxy group, and two R²²'s may be the same as or different from each other. p is an integer from 0 to 5, and when there are at least two p's, the at least two (OSi(R²²)2)'s may be the same as or different from each other.

The number of carbon atoms in the alkylene group of Q³ is, in view of ease of production of the present compound, and in that the resulting surface layer will be more excellent in abrasion resistance, light resistance, and chemical resistance, preferably from 1 to 10, more preferably from 1 to 6, and further preferably from 1 to 4, provided that when the alkylene group has a specific bond between carbon-carbon atoms, the lower limit value is 2.

The number of carbon atoms in the alkyl group of R²¹ is, in view of ease of production of the present compound, preferably from 1 to 6, more preferably from 1 to 3, and further preferably from 1 to 2.

The number of carbon atoms in the alkyl group of R²² is, in view of ease of production of the present compound, preferably from 1 to 6, more preferably from 1 to 3, and further preferably from 1 to 2.

The number of carbon atoms in the alkoxy group of R²² is, in that the present compound is excellent in storage stability, preferably from 1 to 6, more preferably from 1 to 3, and further preferably from 1 to 2.

p is preferably 0 or 1.

Further, in the present invention, L¹ preferably consists of only the branch point P¹, and more preferably an N atom, a C atom, a Si atom. By selecting them as L¹, a more remarkable effect of abrasion resistance due to the difference in chain length can be achieved.

R¹¹ is an alkylene group, or an alkylene group that contains an etheric oxygen atom between carbon-carbon atoms, and when there are a plurality of R¹¹'s, the plurality of R¹¹'s may be the same as or different from each other.

The alkylene group which may contain an etheric oxygen atom in R¹¹ is preferably linear. Further, the number of carbon atoms of the alkylene group is preferably from 1 to 18, more preferably from 1 to 12, and further preferably from 1 to 8. Further, R¹¹ is preferably an alkylene group that does not contain an etheric oxygen atom.

Further, in the present invention, in view of the effect of abrasion resistance due to the difference in chain length, when there are a plurality of R¹¹'s in the molecule, all these R¹¹'s are preferably the same.

T¹ is —SiR^{a1}_{z1}R^{a11}_{3-z1}.

Here, R^{a1} is a hydroxyl group or a hydrolyzable group, and when there are a plurality of R^{a1}'s, the plurality of R^{a1}'s may be the same as or different from each other, R^{a11} is a nonhydrolyzable group, and when there are a plurality of R^{a11}'s, the plurality of R^{a11}'s may be the same as or different from each other.

z1 is an integer from 0 to 3, and when x1 is at least 2, the plurality of z1's in the molecule may be the same as or different from each other. Here, at least one of z1's is an integer from 1 to 3.

When R^{a1} is a hydroxyl group, R^{a1} constitutes a silanol (Si-OH) group along with an Si atom. Further, the hydrolyzable group undergoes hydrolysis to form a hydroxyl group. Such silanol groups are intermolecularly reacted to form a Si—O—Si bond. The silanol groups further undergo dehydration condensation with a hydroxyl group (substrate-OH) on the surface of the substrate to form a chemical bond (substrate-O—Si). Since the present compound (A¹) contains at least one T¹, the present compound is excellent in the wear resistance after the surface layer is formed.

Examples of the hydrolyzable group of R^{a1} include an alkoxy group, an aryloxy group, a halogen atom, an acyl group, an acyloxy group, or an isocyanate group (—NCO). The alkoxy group is preferably a C1-4 alkoxy group. The acyl group is preferably a C1-6 acyl group. The acyloxy group is preferably a C1-6 acyloxy group.

R^{a1} is, in view of ease of production of the present compound, preferably a C1-4 alkoxy group or a halogen atom. The alkoxy group in R^{a1} is, in that the present compound will be more excellent in storage stability and outgassing at the time of reaction is small, preferably a C1-4 alkoxy group, and in a case where the present compound is required to have long-term storage stability, particularly preferably an ethoxy group, and in a case where the hydrolysis reaction time is to be short, particularly preferably a methoxy group. The halogen atom is preferably a chlorine atom.

Examples of the nonhydrolyzable group of R^{a11} include a hydrogen atom or a monovalent hydrocarbon group. The hydrocarbon group may be an alkyl group, a cycloalkyl group, an alkenyl group, or an allyl group. In view of ease of production and the like, the hydrocarbon group is preferably an alkyl group. Further, in view of ease of production and the like, the number of carbon atoms of the hydrocarbon group is preferably from 1 to 6, more preferably from 1 to 3, and further preferably from 1 to 2.

The number z1 of R^{a1}'s in one T¹ is an integer from 0 to 3. When there is only one T¹ in the molecule, z1 is an integer from 1 to 3. Further, when there are a plurality of T¹'s in the molecule, at least one of the plurality of z1's is an integer from 1 to 3.

In view of adhesion with the substrate, even when there are a plurality of z1's, z1's are each preferably from 1 to 3, more preferably 2 or 3, and further preferably 3.

Specific examples of T¹ include —Si(OCH₃)₃, —SiCH₃ (OCH₃)₂, —Si(OCH₂CH₃)₃, —SiCl₃, —Si(OCOCH₃)₃, and —Si(NCO)₃. In view of ease of handling at the time of production, T¹ is particularly preferably —Si(OCH₃)₃.

The number x1 of T¹'s in one molecule of the compound (A¹) may be any number from 1 to 20. In view of ease of preparation, ease of handling of the compound (A1), and the like, x1 is preferably from 1 to 12, and more preferably from 1 to 6.

When there are at least two T¹'s in one molecule of the compound (A1), the T¹'s may have the same structure or may have different structures.

### Compound (A2)

The compound (A2) is a compound represented by the following formula (A2).

R^{f2}—(OR^{f12})_{y2}—O—R²-L²-(R¹²-T²)ₓ₂ . . . (A2)
where, the symbols of the above formula have already been described above.

The compound (A2) and the compound (A1) are different from each other since
the chain length a1 of —O—R¹-L¹-R¹¹— in the formula (A1) and
the chain length a2 of —O—R²-L²-R¹²— in the formula (A2) are different from each other. Except this point, the embodiment of the compound (A2) is the same as that of the above compound (A1).

That is, embodiments of R^{f2}, R^{f12}, y2, R², L², R¹², T², and x2 respectively correspond to R^{f1}, R^{f11}, y1, R¹, L¹, R¹¹, T¹, and x1 in the above compound (A1), and can be used interchangeably. The same is applied to preferable embodiments as well.

A preferable combination of the compound (A1) with the compound (A2) in a case where the compound (A1) and the compound (A2) are both used will be described.

R^{f1} and R^{f2} preferably have the same structure so that abrasion resistance can be further improved.

The basic structure of R^{f11} is preferably the same as that of R^{f12}. Specifically, when, for example, R^{f11} has the structure represented by the above formula (G2), R^{f12} also preferably has the structure represented by the above formula (G2). Here, the numbers of repetition of units m1 and m2 may be the same as or different from each other. Further, the bonding order of (OG^{f1}) and (OG^{f2}) may be the same as or different from each other. In the surface layer obtained from the present composition, a reactive silyl group is arranged on the substrate thereof and a polyfluoropolyether chain is arranged on a surface that is opposite to the substrate. The polyfluoropolyether chain contains a large amount of ether bonds, is relatively flexible, and is estimated to move in a flexible manner against abrasion. It is estimated, in the present invention, that, by using at least two compounds which are relatively rigid in the molecule and whose lengths (chain lengths) from the linking group to the reactive silyl group (in the case of the compound (A1), R¹-L¹-R¹¹) are different from each other, abrasion resistance will be improved and the polyfluoroether chain is not particularly limited as long as the basic structure (the length of fluoroalkylene R^{f11}) is the same.

The same is applied to the case of the formulae (G3) and (G4). When R^{f11} has the structure represented by the above formula (G3), R^{f12} preferably has the structure represented by the above formula (G3). When R^{f11} has the structure represented by the above formula (G4), R^{f12} also preferably has the structure represented by the above formula (G4). Here, the numbers of repetition of units m2 to m4 may be the same as or different from each other. Further, the bonding order of (OG^{f2}) and (OG^{f4}) may be the same as or different from each other.

Further, L¹ and L² preferably have the same structure so that abrasion resistance can be further improved.

R¹ and R² each preferably have the structure represented by the above formula (C). More preferably, a+b in R¹ and a+b in R² are values different from each other. That is, the difference between the chain length a1 of the compound (A1) and the chain length a2 of the compound (A2) is preferably due to the difference in the length between R¹ and R².

While T¹ and T² may be the same or different from each other, they are preferably the same.

Further, while x1 and x2 may be the same or different from each other, they are preferably the same.

### Compound (B1)

A compound (B1) is a compound represented by the following formula (B1).

(T³-R¹³)ₓ₃-L³-R³—(OR^{f13})_{y3}—O—R²³-L¹³-(R³³-T¹³)ₓ₁₃ . . . (B1)
where, the symbols of the above formula have already been described above.

The compound (B1) is different from the compound (A1) in that a reactive silyl group is arranged on both sides of a polyfluoropolyether chain.

Further, the chain length a1 of the compound (A1) is different from one of two chain lengths of the chain length b1 of —R¹³-L³-R³—O— of the compound (B1) and the chain length b11 of —O—R²³-L¹³-R³— of the compound (B1).

Except for the aforementioned points, the embodiment of the compound (B1) is similar to that of the compound (A1).

That is, embodiments of R¹³, T³, x3, L³, R³, R^{f13}, y3, R²³, L¹³, R³³, T¹³, and x13 in the compound (B1) respectively correspond to R¹¹, T¹, x1, L¹, R¹, R^{f1}, y1, R¹, L¹, R¹¹, T¹, and x1 in the compound (A1), and can be used interchangeably. The same is applied to preferable embodiments as well.

Note that L³ and L¹³ in the compound (B1) preferably have the same structure.

R³ and R²³ preferably have the same structure. R¹³ and R³³ preferably have the same structure. While T³ and T¹³ may be the same or different from each other, they are preferably the same. Further, x3 is preferably the same as x13.

A preferable combination of the compound (A1) with the compound (B1) in a case where the compound (A1) and the compound (B1) are both used will be described.

The basic structure of R^{f11} is preferably the same as that of R^{f13}. Specifically, when, for example, R^{f11} has the structure represented by the above formula (G2), R^{f13} also preferably has the structure represented by the above formula (G2). Here, the numbers of repetition of units m1 and m2 may be the same as or different from each other. Further, the bonding order of (OG^{f1}) and (OG^{f2}) may be the same as or different from each other. The same is applicable to the formulae (G3) and (G4). When R^{f11} has the structure represented by the above formula (G3), R^{f13} also preferably has the structure represented by the above formula (G3), and when R^{f11} has the structure represented by the above formula (G4), R^{f13} also preferably has the structure represented by the above formula (G4). Here, the numbers of repetition of units m2 to m4 may be the same as or different from each other. Further, the bonding order of (OG^{f2}) and (OG4) may be the same as or different from each other.

Further, L¹, L³, and L¹³ preferably have the same structure so that abrasion resistance can be further improved.

R¹, R³, and R²³ each preferably have the structure represented by the above formula (C). More preferably, a+b in R¹ is different from a+b in R³ or R²³. That is, the difference between the chain length a1 of the compound (A1) and at least one of the chain length b1 or b11 of the compound (B1) preferably occurs due to the difference in the length between R¹ and R³ or R²³. When R³ and R²³ have the same structure, the chain length a1 is different from the chain length b1 and the chain length b11.

R¹¹, R¹³, and R³³ preferably have the same structure.

While T¹, T³, and T¹³ may be the same or different from each other, they are preferably the same.

Further, while x1, x3, and x13 may be the same or different from each other, they are preferably the same.

### Compound (B2)

The compound (B2) is a compound represented by the following formula (B2).

(T⁴-R¹⁴)ₓ₄-L⁴-R⁴—(OR^{f14})_{y4}—O—R²⁴-L¹⁴-(R³⁴-T¹⁴)ₓ₁₄ . . . (B2)
where, the symbols of the above formula have already been described above.

In the compound (B2) and the above compound (B1), there is a difference between the lengths in at least one pair of:
a set of the chain lengths b1 of —R¹³-L³-R³—O— and the chain lengths b11 of —O—R²³-L¹³-R³³— in the formula (B1), and
a set of the chain lengths b2 of —R¹⁴-L⁴-R⁴—O— and the chain lengths b12 of —O—R²⁴-L¹⁴-R³⁴— in the formula (B2).

Except the above point, the embodiment of the compound (B2) is the same as that of the above compound (B1).

That is, embodiments of R¹⁴, T⁴, x4, L⁴, R⁴, R^{f14}, y4, R²⁴, L¹⁴, R³⁴, T¹⁴, and x14 of the compound (B2) respectively correspond to R¹³, T³, x3, L³, R³, R^{f13}, y3, R²³, L¹³, R³³, T¹³, and x13 of the compound (B1), and can be used interchangeably. The same is applied to preferable embodiments as well. The details thereof have been described with regard to the compound (A1) and the compound (B1).

A preferable combination of the compound (B1) with the compound (B2) in a case where the compound (B1) and the compound (B2) are both used will be described.

The basic structure of R^{f13} is preferably the same as that of R^{f14}. Specifically, when, for example, R^{f13} has the structure represented by the above formula (G2), R^{f14} also preferably has the structure represented by the above formula (G2). Here, the numbers of repetition of units m1 and m2 may be the same as or different from each other. Further, the bonding order of (OG^{f1}) and (OG^{f2}) may be the same as or different from each other. The same is applied to the formulae (G3) and (G4) as well. When R^{f13} has the structure represented by the above formula (G3), R^{f14} also preferably has the structure represented by the above formula (G3). When R^{f13} has the structure represented by the above formula (G4), R^{f14} also preferably has the structure represented by the above formula (G4). Here, the numbers of repetition of units m2 to m4 may be the same as or different from each other. Further, the bonding order of (OG^{f2}) and (OG^{f4}) may be the same as or different from each other.

Further, L³, L¹³, L⁴, and L¹⁴ preferably have the same structure so that abrasion resistance can be further improved.

R³, R²³, R⁴, and R²⁴ each preferably have the structure represented by the above formula (C), a+b in R³ is preferably different from a+b in R⁴, and a+b in R²³ is preferably different from a+b in R²⁴. Further, the value of a+b in R³ is preferably the same as the value of a+b in R²³, the value of a+b in R⁴ is preferably the same as the value of a+b in R²⁴, and the value of a+b in R³ is preferably different from the value of a+b in R⁴. That is, the difference between the chain lengths b1 and b11 of the compound (B1) and the chain lengths b2 and b12 of the compound (B2) preferably occurs due to the difference in the lengths of R³, R²³, R⁴, and R²⁴.

R¹³, R³³, R¹⁴, and R³⁴ preferably have the same structure.

While T³, T¹³, T⁴, and T¹⁴ may be the same or different from each other, they are preferably the same.

Further, while x3, x13, x4, and x14 may be the same or different from each other, they are preferably the same.

The molecular weight of each of the compound (A1), the compound (A2), the compound (B1), and the compound (B2) is preferably from 500 to 100,000, and more preferably from 1,000 to 20,000. Further, the molecular weight distribution (Mw/Mn) of each compound in the present composition is preferably from 1.0 to 2.0, and particularly preferably from 1.0 to 1.3. The molecular weight and the molecular weight distribution are preferably within these ranges so that each compound has low viscosity, low evaporation component, and excellent uniformity when dissolved in solvent. The molecular weight and the molecular weight distribution of the present compound, which can be measured by gel permeation chromatography, are values obtained in terms of polystyrene.

The present composition contains at least two compounds selected from the aforementioned compound (A1), compound (A2), compound (B1), and compound (B2) and meets the following (I) to (III), whereby the present composition is particularly excellent in abrasion resistance.
(I) When the composition contains the compound represented by the formula (A1) and the compound represented by the formula (A2),
the chain length a1 of —O—R¹-L¹-R¹¹— in the formula (A1), and
the chain length a2 of —O—R²-L²-R¹²— in the formula (A2) are different from each other,
where, when there are a plurality of T¹'s and a plurality of T²'s, at least one pair of the plurality of pairs of the chain lengths a1 and chain lengths a2 are different from each other.
(II) When the composition contains the compound represented by the formula (B1) and the compound represented by the formula (B2),
there is a difference between the lengths in at least one pair of:
a set of the chain lengths b1 of —R¹³-L³—R³—O— and the chain lengths b11 of —O—R²³-L¹³-R³³— in the formula (B1) and
a set of the chain lengths b2 of —R¹⁴-L⁴-R⁴—O— and the chain lengths b12 of —O—R²⁴-L¹⁴-R³⁴— in the formula (B2).
(III) In a case other than the above (I) and (II),
the chain length a1 or the chain length a2 is different from one of the chain lengths b1 or the chain lengths b11 or one of the chain lengths b2 or the chain lengths b12.

A specific determination method will be described.

### Regarding (I)

The chain length a1 of the compound (A1) represents the number of atoms constituting “—O—R¹-L¹-R¹¹—” that links R^{f11} to T¹. When the carbon chain has a cyclic structure, the chain length a1 of the compound (A1) represents the number of atoms constituting the shortest carbon chain. There are x1 chain lengths a1. For example, in the case of the following compound (A1-10), R¹ is CF₂CH₂, L¹ is C(-)₃, R¹¹ is CH₂CH₂CH₂, which is the same in all of the three chains. Therefore, there are three chain lengths a1, and all of them are 7. In this case, the set of the chain lengths a1 is also shown as (7, 7, 7).

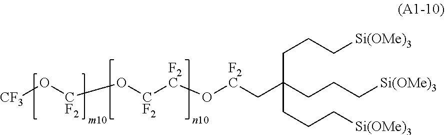

Note that the numbers of repetition of units m10 and n10 are each independently 1 to 200.

In a method similar to that described above, the chain length a2 of the compound (A2) is obtained. The chain length a2 of the compound (A2) represents the number of atoms constituting “—O—R²-L²-R¹²—” that links R^{f12} to T². When this carbon chain has a cyclic structure, the chain length a2 of the compound (A2) represents the number of atoms constituting the shortest carbon chain. There are x2 chain lengths a2. For example, in the case of the following compound (A2-10), R² is CF₂CF₂CH₂, L² is C(-)₃, and R¹² is CH₂CH₂CH₂, which is the same in all of the three chains. Therefore, there are three chain lengths a2, and all of them are 8. In this case, the set of the chain lengths a2 is also shown as (8,8,8).

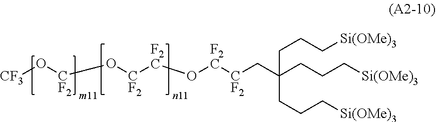

Note that the numbers of repetition of units m11 and n11 are each independently 1 to 200.

When the number of chain lengths a1 is the same as the number of chain lengths a2, as in the combination of the compound (A1-10) with the compound (A2-10), each of the chain lengths a1 is compared with each of the chain lengths a2 in accordance with a descending order of the chain lengths, and if there is a difference between the lengths in at least one pair of the chain lengths, it is determined that the above (I) is met. Specifically, the set (7,7,7) of the chain lengths a1 is compared with the set (8,8,8) of the chain lengths a2 in accordance with a descending order of the chain lengths. In this case, the lengths are different from each other in all of the three pairs, which means there is a difference between the lengths in at least one pair of the chain lengths. Therefore, it is determined that the above (I) is met.

Likewise, the following describes the explanation that a combination of the compound (A1-11) having two T¹'s and the compound (A2-11) having two T²'s satisfies (I).

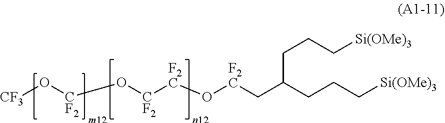

Note that the numbers of repetition of units m12 and n12 are each independently 1 to 200.

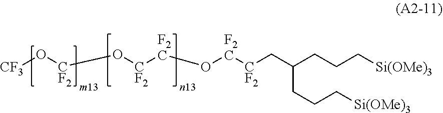

Note that the numbers of repetition of units m13 and n13 are each independently 1 to 200.

The set of the chain lengths a1 of the compound (A1-11) is (7,7) and the set of the chain lengths a2 of the compound (A2-11) is (8,8). Accordingly, when the set (7,7) of the chain lengths a1 is compared with the set (8,8) of the chain lengths a2 in accordance with a descending order of the chain lengths, the lengths are different from each other in two both pairs, which means there is a difference between the lengths in at least one pair of the chain lengths. Therefore, it is determined that the above (I) is met.

In the combination of the compound (A1-10) with the compound (A2-11), when the set (7,7,7) of the chain lengths a1 of the compound (A1-10) is compared with the set (8,8) of the chain lengths a2 of the compound (A2-11) in accordance with a descending order of the chain lengths, the lengths are different from each other in two pairs, which means there is a difference between the lengths in at least one pair of the chain lengths. Therefore, it is determined that the above (I) is met.

Further, in the combination of the compound (A1-10) with the compound (A1-11), when the set (7,7,7) of the chain lengths of the compound (A1-10) is compared with the set (7,7) of the chain lengths of the compound (A1-11) in accordance with a descending order of the chain lengths, there are no pairs in which the lengths are different from each other. Therefore, it is not determined that the above (I) is met.

### Regarding (II)

The method for obtaining each of the chain lengths is similar to that described above. One of the set of the chain lengths b1 and the set of the chain lengths b11 of the compound (B1) having the longest lengths (e.g., the set of the chain lengths b1) is compared with one of the set of the chain lengths b2 and the set of the chain lengths b12 of the compound (B2) having the longest lengths (e.g., the set of the chain lengths b2) in accordance with a descending order of the chain lengths, and when there is a difference between the lengths in at least one pair of the chain lengths, it is assumed that the above (II) is met.

When the lengths of the sets of the chain lengths having the longest lengths match each other, the lengths of the other sets (e.g., the chain length b11 and the chain length b12) are compared with each other. The lengths of these sets are compared with each other in accordance with a descending order of the chain lengths, and when there is a difference between the lengths in at least one pair of the chain lengths, it is assumed that the above (II) is met. Even when the respective numbers of chains to be compared with each other are different from each other, they are compared with each other in accordance with a descending order of the chain lengths, and when there is a difference between the lengths in at least one pair of the chain lengths, it is assumed that the above (II) is met.

Hereinafter, by using the compound (B1-10) and the compound (B2-10), a method for determining whether or not the above (II) is met will be specifically described.

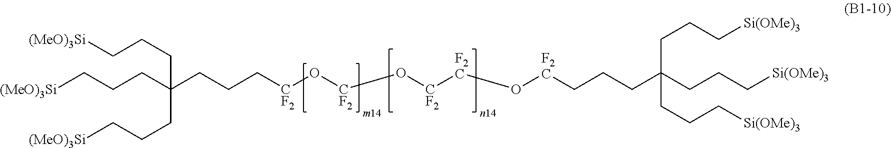

Note that the numbers of repetition of units m14 and n14 are each independently 1 to 200.

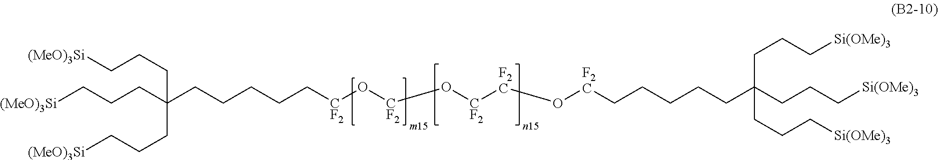

Note that the numbers of repetition of units m15 and n15 are each independently 1 to 200.

The chain length b1 of the compound (B1-10) represents the number of atoms constituting “—R¹³-L³-R³—O—” and the chain length b11 of the compound (B1-10) represents the number of atoms constituting “—O—R²³-L¹³-R³³—”. When the carbon chain has a cyclic structure, the chain length b1 and the chain length b11 each represent the number of atoms constituting the shortest carbon chain. R³ in the compound (B1-10) is CF₂CH₂CH₂CH₂, L³ is C(-)₃, and R¹³ is CH₂CH₂CH₂, which is the same in all of the three chains. Therefore, there are three chain lengths b1, and all of them is 9. In this case, the set of the chain lengths b1 is also shown as (9,9,9). Further, R²³ in the compound (B1-10) is CF₂CH₂CH₂CH₂, L¹³ is C(-)₃, and R³³ is CH₂CH₂CH₂, which is the same in all of the three chains. Therefore, there are three chain lengths b11, and all of them are 9. In this case, the set of the chain lengths b11 is also shown as (9,9,9).

The chain length b2 of the compound (B2-10) represents the number of atoms constituting “—R¹⁴-L⁴-R⁴—O—” and the chain length b12 of the compound (B2-10) represents the number of atoms constituting “—O—R²⁴-L¹⁴-R³⁴—”. When the carbon chain has a cyclic structure, the chain length b2 and the chain length b12 each represent the number of atoms constituting the shortest carbon chain. R⁴ in the compound (B2-10) is CF₂CH₂CH₂CH₂CH₂CH₂, L⁴ is C(-)₃, and R¹⁴ is CH₂CH₂CH₂, which is the same in all of the three chains. Therefore, there are three chain lengths b2, and all of them are 11. In this case, the set of the chain lengths b2 is also shown as (11,11,11). Further, R²⁴ in the compound (B2-10) is CF₂CH₂CH₂CH₂CH₂CH₂, L¹⁴ is C(-)₃, and R³⁴ is CH₂CH₂ CH₂, which is the same in all of the three chains. Therefore, there are three chain lengths b12, and all of them are 11. In this case, the set of the chain lengths b12 is also shown as (11,11,11).

The set of the chain lengths b1 of the compound (B1-10) is (9,9,9) and the set of the chain lengths b11 of the compound (B1-10) is (9,9,9). The set of the chain lengths b2 of the compound (B2-10) is (11,11,11) and the set of the chain lengths b12 of the compound (B2-10) is (11,11,11). One of the set of the chain lengths b1 and the set of the chain lengths b11 having the largest length (in this case, since they have the same length, the set of the chain lengths b1 is to be the comparison target) is compared with one of the set of the chain lengths b2 and the set of the chain lengths b12 having the largest length (in this case, since they have the same length, the set of the chain lengths b2 is to be the comparison target) in accordance with a descending order of the chain lengths. Then, the lengths are different from each other in all of the three pairs, which means there is a difference between the lengths in at least one pair of the chain lengths. Therefore, it is determined that the above (II) is met.

Likewise, the following describes the explanation that a combination of a compound (B1-11) having two T³'s and two T¹³'s with a compound (B2-11) having two T⁴'s and two T¹⁴'s satisfies the above (II).

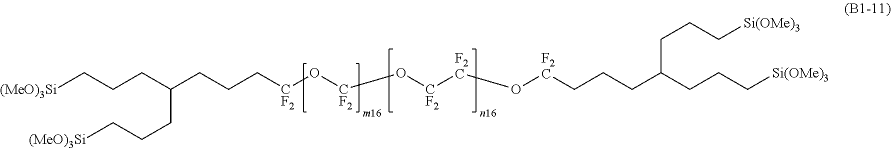

The numbers of repetition of units m16 and n16 are each independently 1 to 200.

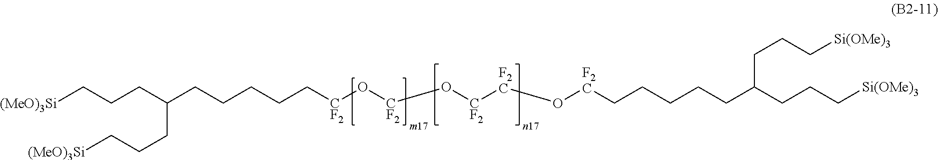

Note that the numbers of repetition of units m17 and n17 are each independently 1 to 200.

The set of the chain lengths b1 of the compound (B1-11) is (9,9) and the set of the chain lengths b11 of the compound (B1-11) is (9,9). The set of the chain lengths b2 of the compound (B2-11) is (11,11) and the set of the chain lengths b12 of the compound (B2-11) is (11,11). Accordingly, one of the set of the chain lengths b1 and the chain lengths b11 having the largest length (in this case, since they have the same length, the set of the chain lengths b1 is to be the comparison target) is compared with one of the set of the chain lengths b2 and the chain lengths b12 having the largest length (in this case, since they have the same length, the set of the chain lengths b2 is to be the comparison target) in accordance with a descending order of the chain lengths. Then the lengths are different from each other in two both pairs, which means there is a difference between the lengths in at least one pair of the chain lengths. Therefore, it is determined that the above (II) is met.

In the combination of the compound (B1-10) with the compound (B2-11), when the set (9,9,9) of the chain lengths b1 of the compound (B1-10), the set (9,9 9) of the chain lengths b11 of the compound (B1-10) (in this case, since they have the same length, the set of chain lengths b1 is to be the comparison target) is compared with the set (11,11) of the chain lengths b2 of the compound (B2-11) and the set (11,11) of the chain lengths b12 of the compound (B2-11) (in this case, since they have the same length, the set of the chain lengths b2 is to be the comparison target) in accordance with a descending order of the chain lengths. Then the lengths are different from each other in two pairs, which means there is a difference between the lengths in at least one pair of the chain lengths. Therefore, it is determined that the above (II) is met.

Further, in the combination of the compound (B1-10) with the compound (B1-11), when the set (9,9,9) of the chain lengths including the longest lengths of the sets of the chain lengths of the compound (B1-10) is compared with the set (9,9) of the chain lengths including the longest lengths of the sets of the chain lengths of the compound (B1-11) in accordance with a descending order of the chain lengths, there are no pairs in which the lengths are different from each other. Therefore, it is not determined that the above (II) is met.

### Regarding (III)

When, for example, the compound (A1) and the compound (B1) are both used, the set of the chain lengths a1 and the set of the chain lengths b1 are compared with each other and the set of the chain lengths a1 and the set of the chain lengths b11 are compared with each other. They are compared in accordance with a descending order of the chain lengths, and when there is a difference between the lengths in at least one pair of the chain lengths, it is assumed that the above (III) is met. Even when the numbers of chains to be compared with each other are different from each other, they are compared with each other in accordance with a descending order of the chain lengths, and when there is a difference between the lengths in at least one pair of the chain lengths, it is assumed that the above (III) is met.

When, for example, the compound (A1-10) and the compound (B1-10) are combined with each other, the set (7,7,7) of the chain lengths a1 is compared with the set (9,9,9) of the chain lengths b1 and the set (7,7,7) of the chain lengths a1 is compared with the set (9,9,9) of the chain lengths b11. In this case, in the comparison between the set of the chain lengths a1 and the sets of the chain lengths b1 and the chain lengths b11, there is a difference between the lengths in at least one pair of the chain lengths. Therefore, it is determined that the above (III) is met.

Among them, the present composition is preferably a composition that contains at least the compound (A1) and the compound (A2) or a composition that contains at least the compound (B1) and the compound (B2), and more preferably a composition that contains at least the compound (A1) and the compound (A2).

When two of the compound (A1), the compound (A2), the compound (B1), and the compound (B2) are combined with each other, the ratio is preferably 5:95 to 95:5 by mass ratio.

When the compound (A1) and the compound (A2) are combined with each other, the ratio is preferably 5:95 to 95:5 by mass ratio. When the compound (B1) and the compound (B2) are combined with each other, the ratio is preferably 5:95 to 95:5 by mass ratio.

The method for producing each compound in the present composition may be selected as appropriate from known methods. For example, the compound (A1) and the compound (B1) may be prepared based on International Patent Publication No. WO2017/038830 and International Patent Publication No. WO2021/054413. For example, by using raw materials having different carbon chain lengths and the like, the compound (A1) and the compound (A2) may be separately prepared. Although the production method is not limited to these methods, according to these methods, it is possible to obtain the present compounds in a high yield. By mixing the prepared compound (A1) with the prepared compound (A2), the present composition can be obtained. The same is applied to the compound (B1) and the like.

The present composition may further contain other compounds within the range in which the effects of the present invention are achieved. The other compounds may be compounds and the like produced as by-products when the compound (A1) and the like are produced.

Specific examples of the present composition may include, for example, a combination of the following compounds. For example, like a combination of the compound (A1-12) with the compound (A2-12), a combination of compounds in which the number following the compound (A1-) is the same as the number following the compound (A2-) is preferably used.

Likewise, like a combination of the compound (B1-12) with the compound (B2-12), a combination of compounds in which the number following the compound (B1-) is same as the number following the compound (B2-) is preferably used.

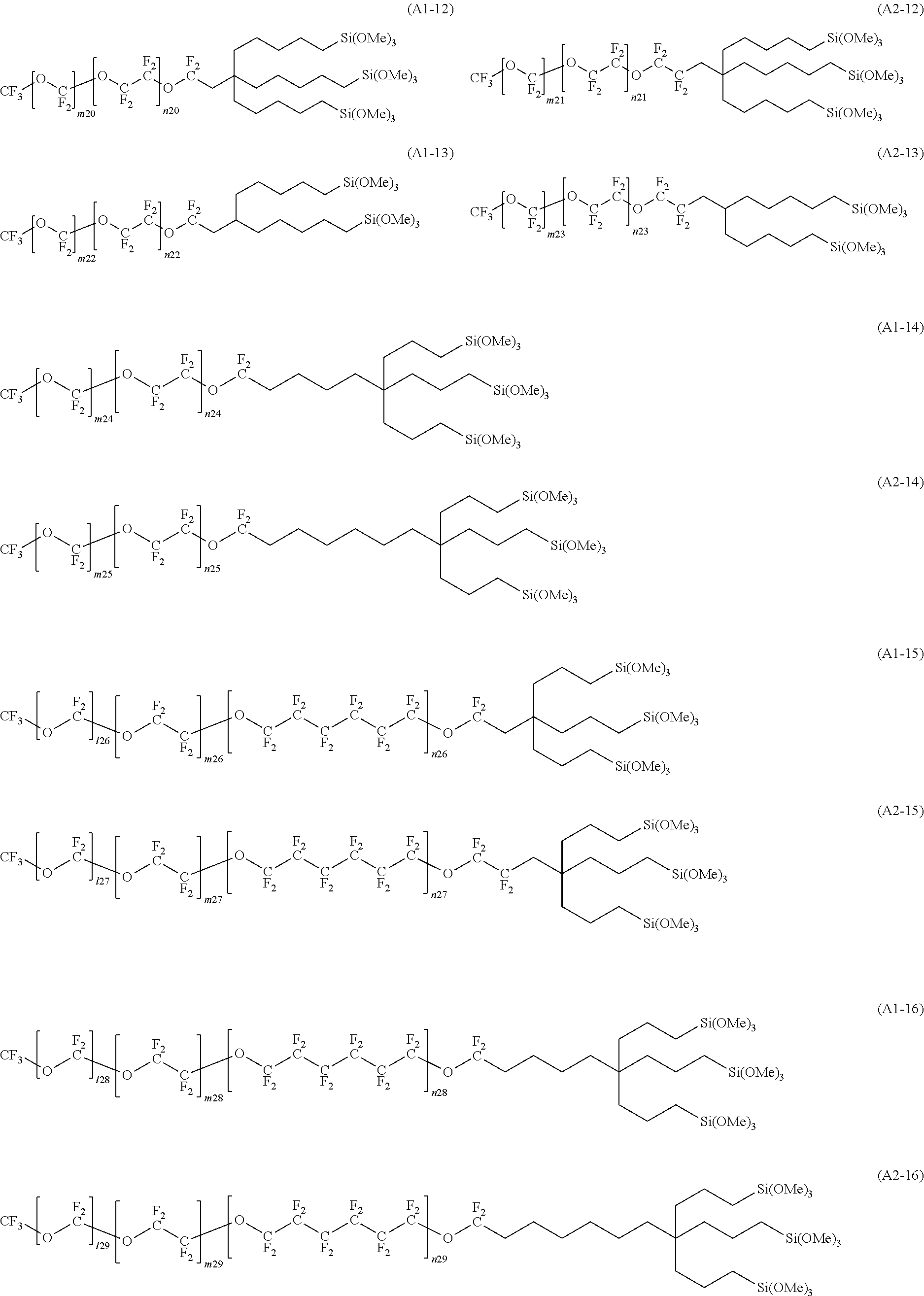

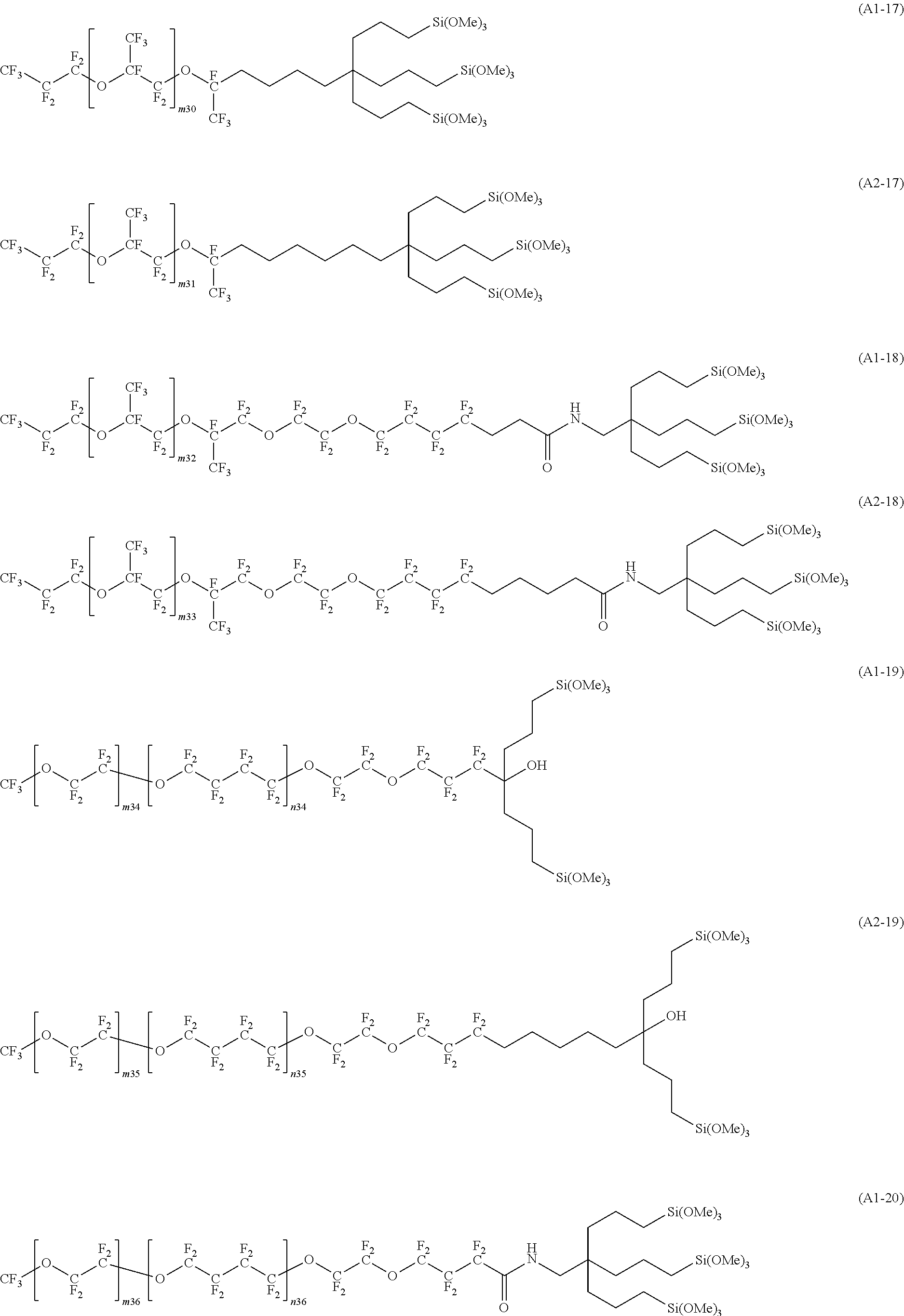

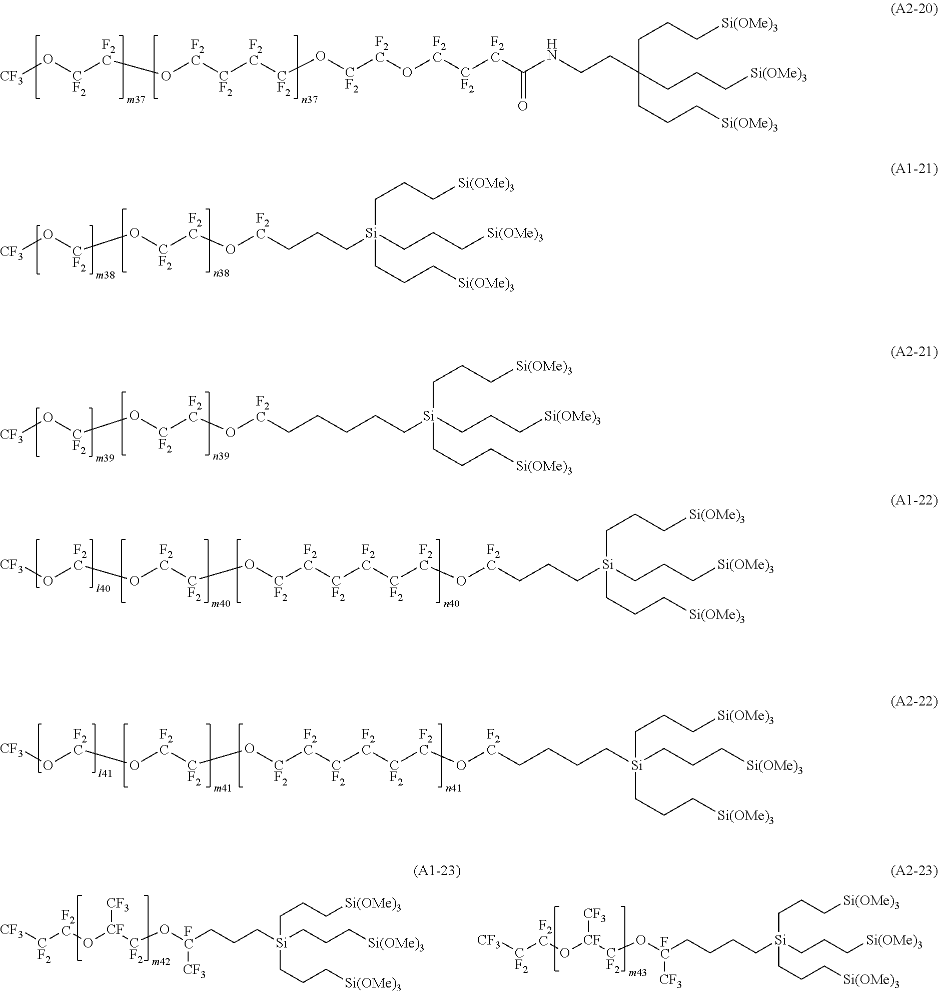

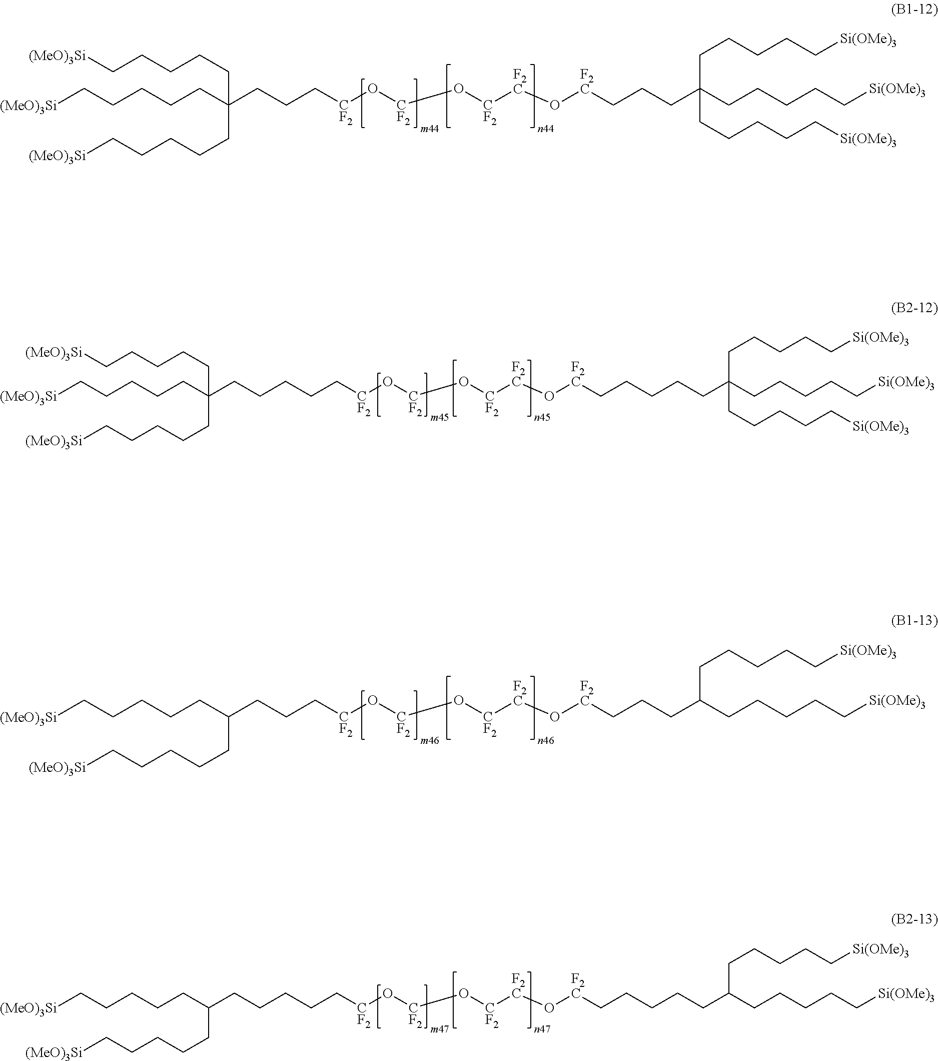

Note that the numbers of repetition of units m20 to m47, n20 to n29, n34 to n41, n44 to n47, 126 to 129, 140, 141 are each independently 1 to 200. Further, while combinations of two compounds are illustrated in the above examples, the present composition may contain at least three compounds selected from the present compounds.

The present composition may contain a fluorinated compound other than the above-described compound (A1), compound (A2), compound (B1), and compound (B2), and at least one of the following impurities. Examples of the impurities include compounds inevitably generated during the production of the present compound and other fluorinated compound. The present composition does not contain a liquid medium described later.

Examples of other fluorinated compound include fluorinated compounds yielded as by-products during the process for producing the present compound (hereinafter also referred to as a “by-product fluorinated compound”), and known fluorinated compounds used in the same application as those of the present compound.

The other fluorinated compound is preferably a compound which is less likely to reduce the properties of the present compound.

The content of the other fluorinated compound is, in order to sufficiently exhibit properties of the present compound, in the total amount of this composition, preferably less than 50% by mass, more preferably less than 30% by mass, and further preferably less than 10% by mass.

Examples of the by-product fluorinated compounds include an unreacted fluorinated compound during the production of the present compound. When the present composition contains the by-product fluorinated compound, a purification process for removing the by-product fluorinated compound or reducing the amount of the by-product fluorinated compound can be simplified.

Examples of the known fluorinated compounds include, for example, compounds described in the following documents.

Perfluoropolyether-modified aminosilanes disclosed in Japanese Unexamined Patent Application Publication No. H11-029585,
silicon-containing organic fluorinated polymers disclosed in Japanese Patent No. 2874715,
organic silicon compounds disclosed in Japanese Unexamined Patent Application Publication No. 2000-144097,
perfluoropolyether-modified aminosilanes disclosed in Japanese Unexamined Patent Application Publication No. 2000-327772,
fluorinated siloxanes disclosed in Published Japanese Translation of PCT International Publication for Patent Application, No. 2002-506887,
organic silicone compounds disclosed in Published Japanese Translation of PCT International Publication for Patent Application, No. 2008-534696,
fluorinated modified hydrogenerated polymers disclosed in Japanese Patent No. 4138936,
compounds disclosed in United States Patent Application Publication No. 2010/0129672, International Patent Publication No. WO 2014/126064, and Japanese Unexamined Patent Application Publication No. 2014-070163,
organosilicon compounds disclosed in International Patent Publication No. WO 2011/060047 and International Patent Publication No. WO 2011/059430,
fluorinated organosilane compounds disclosed in International Patent Publication No. WO 2012/064649,
fluoroxyalkylene group-containing polymers disclosed in Japanese Unexamined Patent Application Publication No. 2012-72272,
fluorinated ether compounds disclosed in International Patent Publication No. WO 2013/042732, International Patent Publication No. WO 2013/121984, International Patent Publication No. WO 2013/121985, International Patent Publication No. WO 2013/121986, International Patent Publication No. WO 2014/163004, Japanese Unexamined Patent Application Publication No. 2014-080473, International Patent Publication No. WO 2015/087902, International Patent Publication No. WO 2017/038830, International Patent Publication No. WO 2017/038832, and International Patent Publication No. WO 2017/187775,
perfluoro(poly)ether-containing silane compounds disclosed in Japanese Unexamined Patent Application Publication No. 2014-218639, International Patent Publication No. WO 2017/022437, International Patent Publication No. WO 2018/079743, and International Patent Publication No. WO 2018/143433,
fluoropolyether group-containing polymer-modified silanes disclosed in Japanese Unexamined Patent Application Publication No. 2015-199906, Japanese Unexamined Patent Application Publication No. 2016-204656, Japanese Unexamined Patent Application Publication No. 2016-210854, and Japanese Unexamined Patent Application Publication No. 2016-222859, and
fluorinated ether compounds disclosed in International Patent Publication No. WO 2018/216630, International Patent Publication No. WO 2019/039226, International Patent Publication No. WO 2019/039341, International Patent Publication No. WO 2019/039186, International Patent Publication No. WO 2019/044479, Japanese Unexamined Patent Application Publication No. 2019-44158, and International Patent Publication No. WO 2019/163282.

Further, examples of the commercial products of the fluorinated compound include KY-100 series (KY-178, KY-185, KY-195, etc.) manufactured by Shin-Etsu Chemical Co., Ltd., SURECO AF series such as SURECO (registered trademark) 2101S manufactured by AGC Inc., OPTOOL (registered trademark) DSX, OPTOOL (registered trademark) AES, OPTOOL (registered trademark) UF₅₀₃, OPTOOL (registered trademark) UD509, etc., manufactured by DAIKIN INDUSTRIES, LTD.

The proportion of the total content of the compound (A1), the compound (A2), the compound (B1), and the compound (B2) in the present composition is less than 100 mass %, preferably at least 60 mass %, more preferably at least 70 mass %, and further preferably at least 80 mass %.

When the present composition includes other fluorinated compound, the proportion of other fluorinated compound to the total of the compound (A1), the compound (A2), the compound (B1), and the compound (B2) in the present composition and other fluorinated compound is preferably at most 40 mass %, more preferably at most 30 mass %, and further preferably at most 20 mass %.

The total proportion of the compound (A1), the compound (A2), the compound (B1), and the compound (B2) in the present composition and other fluorinated compound is preferably at least 80 mass %, and more preferably at least 85 mass %.

When the content of the compound (A1), the compound (A2), the compound (B1), and the compound (B2) and other fluorinated compound is within the above ranges, the surface layer will be excellent in water/oil repellency, abrasion resistance, fingerprint stain removability, lubricity, and outer appearance.

### Surface Treatment Agent

A surface treatment agent containing the present composition (hereinafter it will be also referred to as the present surface treatment agent) is used in an application where it is desired to maintain, for a long period of time, a performance (abrasion resistance) whereby water/oil repellency is less likely to be lowered even if the surface layer is rubbed repeatedly with fingers, and a performance (fingerprint stain removability) whereby a fingerprint adhering to the surface layer can be readily removed by wiping, for example, as a surface treatment agent for a member constituting a plane of a touch panel to be touched with fingers, a spectacle lens, a display of a wearable terminal, etc.

### Coating Liquid

The coating liquid of the present invention (hereinafter also referred to as “the present coating liquid”) includes the present composition and a liquid medium. The present coating liquid may be any liquid and may be a solution or a dispersion.

It is sufficient that the present coating liquid include the present composition. The present coating liquid may include impurities such as by-products produced in the process for producing the present composition.

The concentration of the present composition in the present coating liquid is preferably from 0.001 to 40 mass %, more preferably from 0.01 to 20 mass %, and further preferably from 0.1 to 10 mass %.

The liquid medium is preferably an organic solvent. The organic solvent may be a fluorinated organic solvent, may be a non-fluorinated organic solvent, or may contain both solvents.

Examples of the fluorinated organic solvent include a fluorinated alkane, a fluorinated aromatic compound, a fluoroalkyl ether, a fluorinated alkylamine, a fluoroalcohol, etc.

The fluorinated alkane is preferably a C4-8 compound. Commercially available products may, for example, be C₆F₁₃H (manufactured by AGC Inc., ASAHIKLIN (registered trademark) AC-2000), C₆F₁₃C₂H₅ (manufactured by AGC Inc., ASAHIKLIN (registered trademark) AC-6000), and C₂F₅CHFCHFCF₃ (manufactured by Chemours, Vertrel (registered trademark) XF).

Examples of the fluorinated aromatic compound include, for example, hexafluorobenzene, trifluoromethylbenzene, perfluorotoluene or bis (trifluoromethyl)benzene.

The fluoroalkyl ether is preferably a C4-12 compound. Commercially available products may, for example, be CF₃CH₂OCF₂CF₂H (manufactured by AGC Inc., ASAHIKLIN (registered trademark) AE-3000), C₄F₉OCH₃ (manufactured by 3M, Novec (registered trademark) 7100), C₄F₉OC₂Hs (manufactured by 3M, Novec (registered trademark) 7200), and C₂F₅CF(OCH₃) C₃F₇ (manufactured by 3M, Novec (registered trademark) 7300).

Examples of the fluorinated alkylamine include, for example, perfluorotripropylamine or perfluorotributylamine.

Examples of the fluoroalcohol include, for example, 2,2,3,3-tetrafluoropropanol, 2,2,2-trifluoroethanol or hexafluoroisopropanol.

The non-fluorinated organic solvent is preferably a compound composed solely of hydrogen atoms and carbon atoms, and a compound composed solely of hydrogen atoms, carbon atoms and oxygen atoms, and may, for example, be a hydrocarbon-based organic solvent, an alcohol-based organic solvent, a ketone-based organic solvent, an ether-based organic solvent, or an ester-based organic solvent.

The content of the liquid medium is preferably from 75 to 99.999 mass %, more preferably from 85 to 99.99 mass %, and particularly preferably from 90 to 99.9 mass % in the present coating liquid.

The present coating liquid may contain other components in addition to the present composition and the liquid medium within a range not to impair the effects of the present invention.

Examples of the other components include, for example, known additives such as an acid catalyst or a basic catalyst which promotes hydrolysis and condensation reaction of the hydrolyzable silyl group.

The content of other components in the present coating liquid is preferably at most 10 mass %, and more preferably at most 1 mass %.

The total concentration of the present composition and other components (hereinafter this may be referred to as a solid content) in the present coating liquid is preferably 0.001 to 40 mass %, more preferably from 0.01 to 20 mass %, further preferably from 0.01 to 10 mass %, and particularly preferably from 0.01 to 1 mass %. The solid content of the coating liquid is a value calculated from the mass of the coating liquid before and after 4 hours of heating at 120° C. with a convection dryer.

### Article

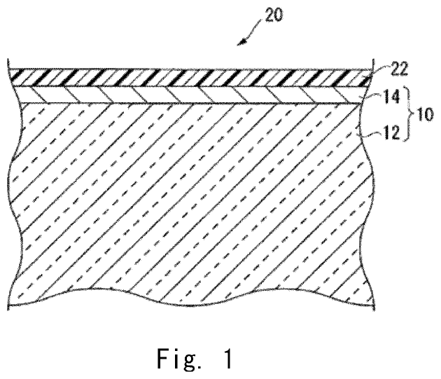

FIG. 1 is a schematic cross-sectional view showing one example of an article according to the present invention. A first article of the present invention is an article20 including a substrate 12, an undercoat layer 14, and a surface layer 22 in this order, in which the undercoat layer 14 contains an oxide containing silicon and the surface layer 22 contains a condensation product of the present composition.

The material and the shape of the substrate 12 in the aforementioned first article may be selected as appropriate according to the application or the like of this article 20. The material of the substrate 12 may, for example, be glass, resin, sapphire, metal, ceramic, stone, or a composite material thereof. The glass may be chemically tempered. In particular, the substrate 12 where water/oil repellency is required may, for example, be a substrate for a touch panel, a substrate for a display, a substrate constituting a case of electronic equipment or the like. A substrate for a touch panel and a substrate for a display have translucency. “Having translucency” means that the normal incidence visible light transmittance in accordance with JIS R3106: 1998 (ISO 9050: 1990) is at least 25%. As the material of a substrate for a touch panel, glass or a transparent resin is preferable.

The substrate 12 may be the one obtained by performing a surface treatment such as a corona discharge treatment, a plasma treatment, or a plasma graft polymerization treatment on the surface of the substrate 12 on which the undercoat layer 14 is provided. The surface that has been subjected to surface treatment is further excellent in adhesion between the substrate 12 and the undercoat layer 14, as a result of which the wear resistance of the surface layer 22 is further improved. The surface treatment is, in view of more excellent wear resistance of the surface layer 22, preferably a corona discharge treatment or a plasma treatment.

The undercoat layer 14 is a layer that contains an oxide containing at least silicon, and may further contain other elements. When the undercoat layer 14 contains silicon oxide, T¹ of the present composition is subjected to dehydration condensation, whereby the surface layer 22 excellent in wear durability, with a Si—O—Si bond formed between the surface layer 22 and the undercoat layer 14, is formed.

The content of the silicon oxide in the undercoat layer 14 is not particularly limited as long as it is at least 65 mass %, and is preferably at least 80 mass %, more preferably at least 85 mass %, and further preferably at least 90 mass %. When the content of the silicon oxide is at least the lower limit value of the above range, the Si—O—Si bond in the undercoat layer 14 is sufficiently formed and mechanical properties of the undercoat layer 14 are sufficiently secured. The content of the silicon oxide is a remaining part obtained by removing the total content of the other elements (for an oxide, an amount in terms of the oxide) from the mass of the undercoat 14.

From the viewpoint of durability of the surface layer 22, the oxide in the undercoat layer 14 further preferably contains at least one element selected from alkaline metal elements, alkaline earth metal elements, platinum group elements, boron, aluminum, phosphorus, titanium, zirconium, iron, nickel, chromium, molybdenum, and tungsten. When the oxide contains these elements, the bonding between the undercoat layer 14 and the present composition is enhanced and the wear resistance is improved.

When the undercoat layer 14 contains at least one element selected from iron, nickel, and chromium, the total content of them is, as expressed as a proportion to silicon oxide, preferably from 10 to 1100 mass ppm, more preferably from 50 to 1100 mass ppm, further preferably from 50 to 500 mass ppm, and particularly preferably from 50 to 250 mass ppm.

When the undercoat layer 14 contains at least one element selected from aluminum and zirconium, the total content of them is preferably from 10 to 2500 mass ppm, more preferably from 15 to 2000 mass ppm, and further preferably from 20 to 1000 mass ppm.

When the undercoat layer 14 contains alkaline metal elements, the total content of them is preferably from 0.05 to 15 mass %, more preferably from 0.1 to 13 mass %, and further preferably from 1.0 to 10 mass %. The alkaline metal elements may, for example, be lithium, sodium, potassium, rubidium or cesium.

When the undercoat layer 14 contains platinum group elements, the total content of them is preferably at least 0.02 mass ppm but at most 800 mass ppm, more preferably at least 0.04 mass ppm but at most 600 mass ppm, and further preferably at least 0.7 mass ppm but at most 200 mass ppm. The platinum group elements may include platinum, rhodium, ruthenium, palladium, osmium, or iridium.

When the undercoat layer 14 contains at least one element selected from boron and phosphorus, the total content of them is, in view of the wear resistance of the surface layer 22, as the ratio of the total molar concentration of boron and phosphorus to the molar concentration of silicon, preferably from 0.003 to 9, more preferably from 0.003 to 2, and further preferably from 0.003 to 0.5.

When the undercoat layer 14 contains alkaline earth metal elements, the total content of them is, from the viewpoint of the wear resistance of the surface layer 22, as the ratio of the total molar concentration of alkaline earth metal elements to the molar concentration of silicon, preferably from 0.005 to 5, more preferably from 0.005 to 2, and further preferably from 0.007 to 2. The alkaline earth metal elements may include lithium, sodium, potassium, rubidium, and cesium.

From the viewpoint of improving adhesion of the present composition and improving water/oil repellency and wear resistance of the article 20, the undercoat layer 14 is preferably a silicon oxide layer including alkali metal atoms. In particular, in the silicon oxide layer, an average concentration of the alkali metal atoms in the region having a depth from the surface that contacts the surface layer 22 of from 0.1 to 0.3 nm is preferably at least 2.0×10¹⁹ atoms/cm³. On the other hand, from the viewpoint of sufficiently securing mechanical properties of the silicon oxide layer, the average concentration of the alkali metal atoms is preferably at most 4.0×10²² atoms/cm³.

The thickness of the undercoat layer 14 is preferably from 1 to 200 nm, and particularly preferably from 2 to 20 nm. When the thickness of the undercoat layer 14 is at least the lower limit value of the above range, sufficient effects to improve the adhesion by the undercoat layer 14 tend to be obtained. When the thickness of the undercoat layer 14 is at most the upper limit value of the above range, the wear resistance of the undercoat layer 14 itself becomes high. A method for measuring the thickness of the undercoat layer 14 may include a method by observing a cross section of the undercoat layer 14 by an electron microscope (such as SEM or TEM) or a method of using an optical interference film thickness meter, a spectroscopic ellipsometer or a profiler.

A method for forming the undercoat layer 14 may, for example, be a method for evaporating a deposition material having a composition of a desired undercoat layer 14 to make it attached to the surface of the substrate 12.

Examples of the deposition method include a vacuum deposition method. The vacuum deposition method is a method of evaporating the deposition material in a vacuum chamber to make it attached to the surface of the substrate 12.

The temperature at the time of deposition (e.g., in a case where a vacuum deposition apparatus is used, the temperature of the boat on which the deposition material is placed) is preferably from 100 to 3000° C., and particularly preferably from 500 to 3000° C.

The pressure at the time of deposition (e.g., in a case where a vacuum deposition apparatus is used, the absolute pressure in the chamber in which the deposition material is placed) is preferably at most 1 Pa, and particularly preferably at most 0.1 Pa.

When the undercoat layer 14 is formed by using the deposition material, one deposition material may be used or two or more deposition materials containing different elements may be used.

Examples of the method of evaporating the deposition material include resistance heating method in which the deposition material is melted and evaporated on a high melting metal boat for resistance heating, or electron gun method in which electron beams are applied to the deposition material to directly heat the deposition material and to melt its surface thereby to evaporate it. The method of evaporating the deposition material is preferably electron gun method in that a high melting substance can be evaporated since local heating is possible, and reaction with the container and inclusion of impurities are less likely to occur since the temperature of the portion not irradiated with the electron beams is low. The deposition material used for the electron gun method is preferably a molten granular material or a sintered body since they are unlikely to scatter even when air currents are generated.

The surface layer 22 on the undercoat layer 14 contains a condensation product of the compound contained in the present composition. The condensation product of the present compound contains a Si—O—Si bond that is formed as a result of condensation of silanol groups (Si—OH) intermolecularly, each of the silanol groups being formed by hydrolysis reaction of a hydrolyzable silyl group in the compound contained in the present composition, and a Si—O—Si bond that is formed as a result of condensation of the silanol group in the present compound with a silanol group on the surface of the undercoat layer 14 or an Si—OM group (where M represents an alkaline metal element). Further, the surface layer 22 may contain a condensation product of a fluorinated compound other than the compound contained in the present composition. That is, the surface layer 22 contains the fluorinated compound having a reactive silyl group in a state where some of or all the reactive silyl groups in the fluorinated compound are condensed.

The thickness of the surface layer 22 is preferably from 1 to 100 nm, and particularly preferably from 1 to 50 nm. When the thickness of the surface layer 22 is at least the lower limit value of the above range, effects by the surface layer 22 will be sufficiently obtained. When the thickness of the surface layer 22 is at most the upper limit value of the above range, high utilization efficiency will be obtained.

The thickness of the surface layer 22 is a thickness obtained by using an X-ray diffractometer for thin film analysis. The thickness of the surface layer 22 is calculated from the oscillation period of an interference pattern of reflected X-rays obtained by X-ray reflectometry by using the X-ray diffractometer for thin film analysis.

The second article of the present invention is an article 20 including an undercoat layer-provided substrate 10 and a surface layer 22 in this order, in which the undercoat layer-provided substrate 10 contains an oxide containing silicon, and the surface layer 22 contains a condensation product of the present composition.

In the second article, the undercoat layer-provided substrate 10 has the composition of the undercoat layer 14 in the first article. Therefore, even when the surface layer 22 is directly formed on the undercoat layer-provided substrate 10, the surface layer 22 is excellent in the wear durability.

The material of the undercoat layer-provided substrate 10 in the second article may be anything that has the composition of the undercoat layer 14, and may, for example, be a glass substrate. Since the details of the material of the undercoat layer-provided substrate 10 are similar to those of the material of the substrate 12 and the undercoat layer 14, the explanation will be omitted. Further, since the structure of the surface layer 22 is also similar to that of the first article, the explanation will be omitted.

### Method for Producing Article

A method for producing the article according to the present invention is a method for forming a surface layer by a dry coating method or a wet coating method using the composition, the surface treatment agent, or the coating liquid.

The present composition and the present surface treatment agent can be directly used for the dry coating method. The present composition and the present surface treatment agent are suitable for forming a surface layer excellent in adhesion by the dry coating method. Examples of the dry coating method include vacuum deposition method, CVD method, and sputtering method. Among them, with a view to suppressing decomposition of the present composition and in view of simplicity of the apparatus, vacuum deposition method can be preferably used.

At the time of vacuum deposition, a pelletized material in which the present composition is carried on a metal porous product consisting of a metal material such as iron or steel may be used. The pelletized material carrying the present composition can be produced by impregnating the metal porous product with a solution of the present composition, followed by drying and removing a liquid medium. As the solution of the present composition, the present coating liquid may be used.

The present surface treatment agent and the present coating liquid can be suitably used for the wet coating method. The wet coating method may include a spin coating method, a wipe coating method, a spray coating method, a squeegee coating method, a dip coating method, a die coating method, an ink-jet method, a flow coating method, a roll coating method, a casting method, a Langmuir-Blodgett method, or a gravure coating method.

In order to improve abrasion resistance of the surface layer, as the case requires, an operation to accelerate the reaction between the present composition and the substrate may be conducted. Such an operation may, for example, be heating, humidification or light irradiation. For example, the substrate having a surface layer formed thereon may be heated in the air containing moisture to accelerate, e.g., a hydrolysis reaction of a hydrolyzable group, reaction of a hydroxyl group or the like on the surface of the substrate with silanol groups, and formation of a siloxane bond by condensation reaction of the silanol groups.

After the surface treatment, the compound in the surface layer, which is not chemically bonded to other compound or the substrate, may be removed as the case requires. Specific method may include, for example, a method of rinsing the surface layer with a solvent or a method of wiping the surface layer with cloth impregnated with a solvent.

### EXAMPLES

While the present invention will be described hereinafter in further detail using Examples, the present invention is not limited to these Examples. In the following, “%” is “mass %” unless otherwise specified. Examples 2 to 9 and Example 11 correspond to Examples and Examples 1 and 10 correspond to comparative examples.

### Preparation Example 1

According to the method for preparing the compound (B) of Preparation Example 2 of International Patent Publication No. WO2018/143433, the following compound (A1-1) was obtained.

CF₃—O—(CF₂CF₂O)₂₀(CF₂O)₁₆—CF₂CONHCH₂C(CH₂CH₂CH₂Si(OCH₃)₃)₃ . . . Formula (A1-1)

### Preparation Example 2

In the same manner as in the preparation of the compound (B) in Preparation Example 2 of International Patent Publication No. WO2018/143433 except that CF₃O(CF₂CF₂O)₂₀(CF₂O)₁₆CF₂CH₂COOCH₃ was used instead of CF₃O(CF₂CF₂O)₂₀(CF₂O)₁₆CF₂COOCH₃ in Preparation Example 1, the following compound (A2-1) was obtained.

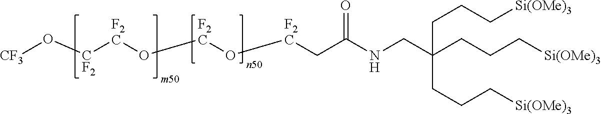

The average values of the numbers of repetition of units m50 and n50 are respectively 20 and 16.

Note that CF₃O(CF₂CF₂O)₂₀(CF₂O)₁₆CF₂CH₂COOCH₃ was prepared based on the following documents, the raw material being changed to CF₃O(CF₂CF₂O)₂₀(CF₂O)₁₆CF₂I.

Example 11 of International Patent Publication No. WO2013/121984, Journal of Fluorine Chemistry (1988), 41(2), 173-183, and Japanese Unexamined Patent Application Publication No. 2015-096545.

### Preparation Example 3

According to the method for preparing the compound (VIII) in Example 21 of International Patent Publication No. WO2021/054413, the following compound (A1-2) was obtained.

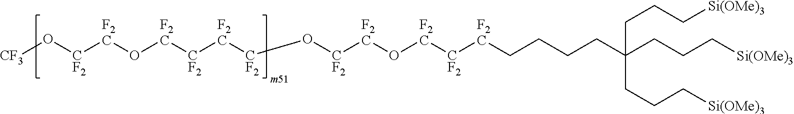

The average value of the numbers of repetition of unit m51 is 12.

### Preparation Example 4

In the same manner as in the method for preparing the compound (VII) in Example 21 of International Patent Publication No. WO2021/054413 except that the compound in [Chemical 16] was used instead of the compound in [Chemical 33] in Preparation Example 11, the following compound (A2-2) was obtained.

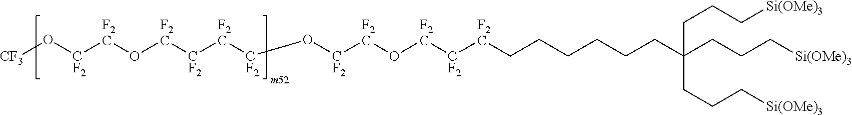

The average value of the numbers of repetition of unit m52 is 12.

### Preparation Example 5

According to the method for preparing the compound (1C-1) in Example 3 of International Patent Publication No. WO2017/038832, the following compound (A1-3) was obtained.

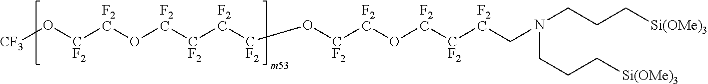

The average value of the numbers of repetition of unit m53 is 13.

### Preparation Example 6

In the same manner as in the preparation of the compound (1C-1) in Example 3 of International Patent Publication No. WO2017/038832 except that CF₃O—(CF₂CF₂OCF₂CF₂CF₂CF₂O)₁₃—CF₂CF₂—O—CF₂CF₂CF₂—CH₂CH₂OH was used instead of the compound (15C-1), the following compound (A2-3) was obtained.

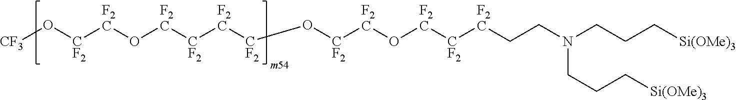

The average value of the numbers of repetition of unit m54 is 13.

Note that the above CF₃O—(CF₂CF₂OCF₂CF₂CF₂CF₂O)₁₃—CF₂CF₂—O—CF₂CF₂CF₂—CH₂CH₂OH was prepared based on the following documents.

Example 11 of International Patent Publication No. WO2013/121984 and Journal of Fluorine Chemistry (1988), 41(2), 173-183.

### Preparation Example 7

According to the method for preparing the compound (H) of Preparation Example 8 of International Patent Publication No. WO2018/079743, the following compound (A1-4) was obtained.

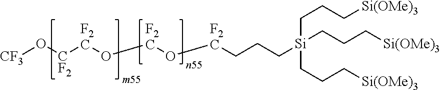

The average values of the numbers of repetition of units m55 and n55 are respectively 20 and 16.

### Preparation Example 8

Further, in the same manner as in the preparation of the compound (H) in Preparation Example 8 of International Patent Publication No. WO2018/079743 except that CF₃(CF₂CF₂)₂₀(CF₂O)₁₆CF₂CH₂CH₂CH₂CH═CH₂ was used instead of CF₃(CF₂CF₂)₂₀(CF₂O)₁₆CF₂CH₂CH═CH₂, the following compound (A2-4) was obtained.

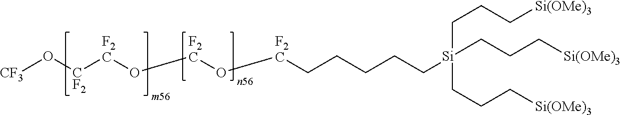

The average values of the numbers of repetition of units m56 and n56 are respectively 20 and 16.

### Preparation Example 9

In the same manner as in the preparation of the compound (VIII) in Example 21 of International Patent Publication No. WO2021/054413 except that a compound (B1-6) was used instead of the compound (B1-2), the following compound (B1-1) was obtained.

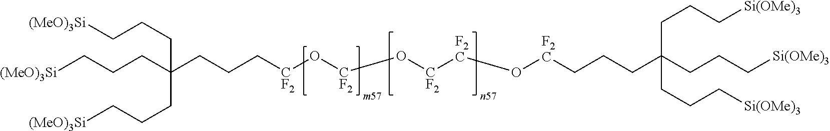

The average values of the numbers of repetition of units m57 and n57 are respectively 22 and 25.

### Preparation Example 10

According to the method for preparing the compound (VIII) in Example 21 of International Patent Publication No. WO2021/054413, the following compound (B2-1) was obtained.

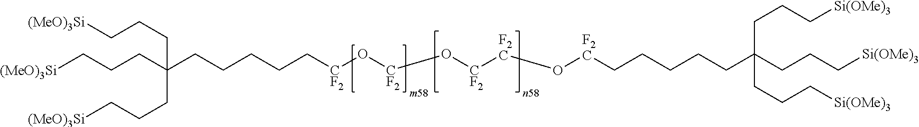

The average values of the numbers of repetition of units m58 and n58 are respectively 22 and 25.

### Preparation Example 11

In the same manner as in the preparation of the compound (B) of International Patent Publication No. WO2018/143433 except that NH₂CH₂CH₂C(CH₂CH═CH₂)₃ was used instead of NH₂CH₂C(CH₂CH═CH₂)₃, the following compound (A2-5) was obtained.

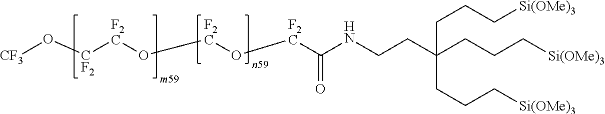

The average values of the numbers of repetition of units m59 and n59 are respectively 20 and 16.

Note that NH₂CH₂CH₂C(CH₂CH═CH₂)₃ was prepared based on the following documents.

Preparation Example 3-1 of International Patent Publication No. WO2021/059981 and Tetrahedron Letters (2015), 56(23), 3658-3661.

### Examples 1 to 11

The compounds prepared in the above Preparation Examples were mixed in the mass ratios as shown in Table 1 to obtain compositions in Examples 1 to 11.

### Production and Evaluation of Article

Using the compositions obtained in the above production method, surface treatment of a substrate was conducted to obtain an article. As the surface treatment method, in each example, the following dry coating method and wet coating method were, respectively, employed. As the substrate, chemically tempered glass was used. With respect to the obtained article, evaluations were carried out by the following methods. The results are shown in the table.

### Dry Coating Method

The dry coating was conducted by using a vacuum deposition apparatus (manufactured by ULVAC Co., VTR³⁵⁰M) (vacuum deposition method). 0.5 g of each compound was filled in a boat made of molybdenum in the vacuum deposition apparatus, and inside of the vacuum deposition apparatus was evacuated of air to a level of at most 1×10⁻³Pa. The boat on which the compound was placed was heated at a temperature raising rate of at most 10° C./min, and at the time when the vapor deposition rate by a quartz oscillator film thickness meter exceeded 1 nm/sec, the shutter was opened to initiate film deposition on the surface of a substrate.

When the film thickness became about 50 nm, the shutter was closed to terminate film deposition on the surface of the substrate. The substrate on which the compound was deposited was subjected to heat treatment at 200° C. for 30 minutes, followed by washing with dichloropentafluoropropane (manufactured by AGC Inc., AK-225) to obtain an article having a surface layer on the surface of the substrate.

### Wet Coating Method

Each composition and C₄F₉₀C₂H₅ (manufactured by 3M, Novec (registered trademark) 7200) as a medium were mixed to prepare a coating liquid having a solid content of 0.05%. A substrate was dipped in the coating liquid and allowed to stand for 30 minutes, whereupon the substrate was taken out (dip coating method).

The coating film was dried at 200° C. for 30 minutes and washed with AK-225 to obtain an article having a surface layer on the surface of the substrate.

### EVALUATION METHODS

### Method for Measuring Contact Angle

The contact angle of about 2 μL of distilled water placed on the surface of the surface layer was measured by using a contact angle measuring apparatus (manufactured by Kyowa Interface Science Co., Ltd., DM-500). Measurements were conducted at five different points on the surface of the surface layer, and the average value was calculated. For the calculation of the contact angle, a 2θ method was employed.

### Initial Contact Angle

With respect to the surface layer, the initial water contact angle was measured by the above-described measuring method. The evaluation standards are as follows.
A (excellent): at least 115 degrees
B (good): at least 105 degrees and less than 115 degrees
C (poor): less than 105 degrees

### Abrasion Resistance (Steel Wool)

With respect to the surface layer, in accordance with JIS L0849: 2013 (ISO 105-X12: 2001), using a reciprocating traverse testing machine (manufactured by KNT Co.), steel wool Bon Star ( #0000) was reciprocated 10,000 times under a pressure of 98.07 kPa at a speed of 320 cm/min, whereupon the water contact angle was measured using the aforementioned method. The smaller the decrease in water-repellency (water contact angle) after the abrasion, the smaller the decrease in performance due to abrasion, and the better the abrasion resistance. The evaluation standards are as follows.
A (good): The change in water contact angle after reciprocation of 10,000 times is at most 10 degrees.
C (poor): The change in water contact angle after reciprocation of 10,000 times is more than 10 degrees.

TABLE 1

| | | | | | Results of Evaluation | |
|---|---|---|---|---|---|---|
| | Composition | | Mass Ratio | | Initial | Abrasion |
| | Compound 1 | Compound 2 | Compound 1 | Compound 2 | Contact Angle | Resistance |
| Example 1 | A1-1 | — | 100 | 0 | A | C |
| Example 2 | A1-1 | A2-1 | 50 | 50 | A | A |
| Example 3 | A1-1 | A2-1 | 70 | 30 | A | A |
| Example 4 | A1-1 | A2-1 | 95 | 5 | A | A |
| Example 5 | A1-2 | A2-2 | 50 | 50 | A | A |
| Example 6 | A1-3 | A2-3 | 50 | 50 | A | A |
| Example 7 | A1-4 | A2-4 | 50 | 50 | A | A |
| Example 8 | B1-1 | B2-1 | 50 | 50 | B | A |
| Example 9 | A1-1 | A2-5 | 50 | 50 | A | A |
| Example 10 | A1-1 | — | 100 | 0 | A | C |
| Example 11 | A1-1 | A2-4 | 50 | 50 | A | A |

It was confirmed, as shown in Table 1, that the surface layer formed using the present composition is excellent in abrasion resistance.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A composition which contains two or more compounds selected from the compound represented by the following formula (A1), the compound represented by the following formula (A2), the compound represented by the following formula (B1), and the compound represented by the following formula (B2) and meets the following (I) to (III).
R^{f1}—(OR^{f11})_{y1}—O—R¹-L¹-(R¹¹-T¹)ₓ₁ (A1)
R^{f2}—(OR^{f12})_{y2}—O—R²-L²-(R¹²-T²)ₓ₂ (A2)
(T³-R¹³)ₓ₃-L³-R³—(OR^{f13})_{y3}—O—R²³-L¹³-(R³³-T¹³)ₓ₁₃ (B1)
(T⁴-R¹⁴)ₓ₄-L⁴-R⁴—(OR^{f14})_{y4}—O—R²⁴-L¹⁴-(R³⁴-T¹⁴)ₓ₁₄ (B2)
where
R^{f1} is a fluoroalkyl group having 1 to 20 carbon atoms,
R^{f11} is a fluoroalkylene group having 1 to 6 carbon atoms, and when there are a plurality of R^{f11}'s, the plurality of R^{f11}'s may be the same as or different from each other,
R¹ is an alkylene group or a fluoroalkylene group,
L¹ is a single bond or a 1+x1 valent group that may contain N, O, S, or Si and may contain a branch point, and atoms bonded to R¹ and R¹¹ are each independently an N, O, S, or Si atom, a carbon atom constituting a branch point, or a carbon atom having an oxo group (═O),
R¹¹ is an alkylene group, or an alkylene group that contains an etheric oxygen atom between carbon-carbon atoms, and when there are a plurality of R¹¹'s, the plurality of R¹¹'s may be the same as or different from each other,
T¹ is —SiR^{a1}_{z1}R^{a11}_{3-z1},
x1 is an integer of at least 1,
R^{a1} is a hydroxyl group or a hydrolyzable group, and when there are a plurality of R^{a1}'s, the plurality of R^{a1}'s may be the same as or different from each other,
R^{a11} is a nonhydrolyzable group, and when there are a plurality of R^{a11}'s, the plurality of R^{a11}'s may be the same as or different from each other,
z1 is an integer from 0 to 3, and when x1 is at least 2, the plurality of z1's in the molecule may be the same as or different from each other, where at least one of z1's is an integer from 1 to 3,
y1 is an integer of at least 1,
R^{f2} is a fluoroalkyl group having 1 to 20 carbon atoms,
R^{f12} is a fluoroalkylene group having 1 to 6 carbon atoms, and when there are a plurality of R^{f12}'s, the plurality of R^{f12}'s may be the same as or different from each other,
R² is an alkylene group or a fluoroalkylene group,
L² is a single bond or a 1+x2 valent group that may contain N, O, S, or Si and may contain a branch point, and atoms bonded to R² and R¹² are each independently an N, O, S, or Si atom, a carbon atom constituting a branch point, or a carbon atom having an oxo group (═O),
R¹² is an alkylene group, or an alkylene group that contains an etheric oxygen atom between carbon-carbon atoms, and when there are a plurality of R¹²'s, the plurality of R¹²'s may be the same as or different from each other,
T² is —SiR^{a2}_{z2}R^{a12}_{3-z2},
x2 is an integer of at least 1,
R^{a2} is a hydroxyl group or a hydrolyzable group, and when there are a plurality of R^{a2}'s, the plurality of R^{a2}'s may be the same as or different from each other,
R^{a12} is a nonhydrolyzable group, and when there are a plurality of R^{a12}'s, the plurality of R^{a12}'s may be the same as or different from each other,
z2 is an integer from 0 to 3, and when x2 is at least 2, the plurality of z2's in the molecule may be the same as or different from each other, where at least one of z2's is an integer from 1 to 3,
y2 is an integer of at least 1,
R^{f13} is a fluoroalkylene group having 1 to 6 carbon atoms, and when there are a plurality of R^{f13}'s, the plurality of R^{f13}'s may be the same as or different from each other,
R³ is an alkylene group or a fluoroalkylene group,
R²³ is an alkylene group or a fluoroalkylene group,
L³ is a single bond or a 1+x3 valent group that may contain N, O, S, or Si and may contain a branch point, and atoms bonded to R³ and R¹³ are each an N, O, S, or Si atom, a carbon atom constituting a branch point, or a carbon atom having an oxo group (═O),
L¹³ is a single bond or a 1+x13 valent group that may contain N, O, S, or Si and may contain a branch point, and atoms bonded to R²³ and R³³ are each an N, O, S, or Si atom, a carbon atom constituting a branch point, or a carbon atom having an oxo group (═O),
R¹³ is an alkylene group, or an alkylene group that contains an etheric oxygen atom between carbon-carbon atoms, and when there are a plurality of R¹³'s, the plurality of R¹³'s may be the same as or different from each other,
R³³ is an alkylene group, or an alkylene group that contains an etheric oxygen atom between carbon-carbon atoms, and when there are a plurality of R³³'s, the plurality of R³³'s may be the same as or different from each other,
T³ and T¹³ are each independently —SiR^{a3}_{z3}R^{a13}_{3-z3},
x3 and x13 are each independently an integer of at least 1,
R^{a3} is a hydroxyl group or a hydrolyzable group, and when there are a plurality of R^{a3}'s, the plurality of R^{a3}'s may be the same as or different from each other,
R^{a13} is a nonhydrolyzable group, and when there are a plurality of R^{a13}'s, the plurality of R^{a13}'s may be the same as or different from each other,
z3 is an integer from 0 to 3 and the plurality of z3's in the molecule may be the same as or different from each other, where at least one of z3's is an integer from 1 to 3,
y 3 is an integer of at least 1,
R^{f14} is a fluoroalkylene group having 1 to 6 carbon atoms, and when there are a plurality of R^{f14}'s, the plurality of R^{f14}'s may be the same as or different from each other,
R⁴ is an alkylene group or a fluoroalkylene group,
R²⁴ is an alkylene group or a fluoroalkylene group,
L⁴ is a single bond or a 1+x4 valent group that may contain N, O, S, or Si and may contain a branch point, and atoms bonded to R⁴ and R¹⁴ are each an N, O, S, or Si atom, a carbon atom constituting a branch point, or a carbon atom having an oxo group (═O),
L¹⁴ is a single bond or a 1+x14 valent group that may contain N, O, S, or Si and may contain a branch point, and atoms bonded to R²⁴ and R³⁴ are each an N, O, S, or Si atom, a carbon atom constituting a branch point, or a carbon atom having an oxo group (═O),
R¹⁴ is an alkylene group, or an alkylene group that contains an etheric oxygen atom between carbon-carbon atoms, and when there are a plurality of R¹⁴'s, the plurality of R¹⁴'s may be the same as or different from each other,
R³⁴ is an alkylene group, or an alkylene group that contains an etheric oxygen atom between carbon-carbon atoms, and when there are a plurality of R³⁴'s, the plurality of R³⁴'s may be the same as or different from each other,
T⁴ and T¹⁴ are each independently —SiR^{a4}_{z4}R^{a14}_{3-z4},
x4 and x14 are each independently an integer of at least 1,
R^{a4} is a hydroxyl group or a hydrolyzable group, and when there are a plurality of R^{a4}'s, the plurality of R^{a4}'s may be the same as or different from each other,
R^{a14} is a nonhydrolyzable group, and when there are a plurality of R^{a14}'s, the plurality of R^{a14}'s may be the same as or different from each other,
z4 is an integer from 0 to 3 and the plurality of z4's in the molecule may be the same as or different from each other, where at least one of z4's is an integer from 1 to 3,
y4 is an integer of at least 1,
(I) when the composition contains the compound represented by the formula (A1) and the compound represented by the formula (A2),
the chain length a1 of —O—R¹-L¹-R¹¹— in the formula (A1), and
the chain length a2 of —O—R²-L²-R¹²— in the formula (A2) are different from each other,
where, when there are a plurality of T¹'s and a plurality of T²'s, at least one pair of the plurality of pairs of the chain lengths a1 and chain lengths a2 are different from each other.
(II) when the composition contains the compound represented by the formula (B1) and the compound represented by the formula (B2),
there is a difference between the lengths in at least one pair of:
a set of the chain lengths b1 of —R¹³-L³—R³—O— and the chain lengths b11 of —O—R²³-L¹³-R³³— in the formula (B1), and
a set of the chain lengths b2 of —R¹⁴-L⁴-R⁴—O— and the chain lengths b12 of —O—R²⁴-L¹⁴-R³⁴— in the formula (B2).
(III) in a case other than the above (I) and (II),
the chain length a1 or the chain length a2 is different from one of the chain lengths b1 or the chain lengths b11 or one of the chain lengths b2 or the chain lengths b12.

2. The composition according to claim 1, comprising the compound represented by the formula (A1) and the compound represented by the formula (A2) or the compound represented by the formula (B1) and the compound represented by the formula (B2).

3. The composition according to claim 2, wherein R^{f1} is the same as R^{f2}.

4. The composition according to claim 2, wherein
L¹ is the same as L², or
L³ is the same as L⁴ and L¹³ is the same as L¹⁴.

5. The composition according to claim 1, wherein R¹, R², R³, R⁴, R²³, and R²⁴ are each independently represented by the following formula (C).
*—(CR⁴¹₂)ₐ—(CH₂)_{b}—** . . . Formula (C)
where
R⁴¹'s are each independently a hydrogen atom, a fluorine atom, or a fluoroalkyl group, where at least one of two R⁴¹'s bonded to one carbon atom is a fluorine atom or a fluoroalkyl group, and the plurality of R⁴¹'s may be the same as or different from each other,
a is an integer from 0 to 6,
b is an integer from 0 to 10,
a+b is an integer from 1 to 16,
*is a connecting bond bonded to O, and
** is a connecting bond bonded to L¹, L², L³, L⁴, L¹³, or L¹⁴.

6. The composition according to claim 5, wherein
a+b in R¹ and a+b in R² are values different from each other, or
a+b in R³ and a+b in R⁴ are values different from each other and a+b in R²³ and a+b in R²⁴ are values different from each other.

7. A surface treatment agent comprising the composition according to claim 1.

8. A coating liquid comprising the composition according to claim 1 and a liquid medium.

9. An article including a surface layer formed of the composition according to claim 1 on a surface of a substrate.

10. A method for producing an article, comprising forming a surface layer by dry coating method or wet coating method by using the composition according to claim 1.

11. An article including a surface layer formed of the composition according to claim 7 on a surface of a substrate.

12. A method for producing an article, comprising forming a surface layer by dry coating method or wet coating method by using the surface treatment agent according to claim 7.

13. A method for producing an article, comprising forming a surface layer by dry coating method or wet coating method by using the coating liquid according to claim 8.
